(19) United States
(12) Patent Application Publication
(10) Pub. No.: US 2005/0152142 A1
(43) Pub. Date: Jul. 14, 2005

(54) Methods and apparatus relating to improved visual recognition and safety

(76) Inventor: Neil Traynor, Bulleen Victoria (AU)

Correspondence Address: DENNISON, SCHULTZ, DOUGHERTY & MACDONALD, 1727 KING STREET, SUITE 105, ALEXANDRIA, VA, 22314, US

(21) Appl. No.: 10/508,693

(22) PCT Filed: Mar. 28, 2003
(86) PCT No.: PCT/AU03/00395

(30) Foreign Application Priority Data
Mar. 28, 2002 (AU) PS 1465

(51) Int. Cl. F21V 21/00

(52) U.S. Cl. 362/249; 362/103; 362/108; 362/153.1

(57) ABSTRACT

A visual recognition and identification apparatus comprising a mounting means (2, 18) adapted for placement in a physical environment wherein the mounting means incorporates one or a plurality of light emitting diodes (1) adapted to provide a visual signal characterised in the light emitting diodes (1) are mounted and physically associated with the printed circuit circuit board (2, 18) wherein the printed circuit board (2, 18) has been modified to provide a distinct angle mounting for the light emitting diodes (1) to provide a defined viewing angle and wherein the printed circuit board (2, 18) is manufactured from the compliant material so as to allow the visual recognition and identification apparatus to be moulded and adapted to a number of environments including fixture to non flat surfaces, incorporation into clothing (19, 21), caps and badges by way of sewing or incorporation into a range of devices.

This invention relates to the methods and apparatus to visually improve the recognition of individuals, equipment, and define, or identify areas of potential physical danger in poor and very low levels of light.

### BACKGROUND OF THE INVENTION

There exists a need to assist with the visual identification of people and objects in low levels of ambient light. Emergency workers are often required to work in dangerous conditions where there is no available general light (including sunlight) or extremely low levels of illumination. The current safety methods used to identify people; equipment or hazards rely heavily on the use of reflective materials combined within either their safety clothing or reflective signs, barriers or other light reflective materials. All these items require the application of a light source such as a torch or spotlight beam reflecting light off these special surfaces back to the eyes of an observer.

Portable emergency high performance floodlights often provide general lighting.

However, the problem is obviously most difficult where there is a low level of visibility such as in smoke, silt, rain and other opaque atmospheres or when non-lineal angles of viewing or a line of sight for an observer does not exist or is obscured. Some incident scenes may not provide a suitable or safe position for the mounting of emergency lights.

Another problem is the glare factor created by a bright intensive light within a dark background. The emergency worker carries a considerable load of equipment and clothing onto sites. Often they will wear a miner's type headlight to allow their hands to be free, unfortunately, this means they are often invisible to people behind them. They are also dependent on guessing the correct place to look if wishing to locate a hazard beyond their existing beam of light. Fellow workers may find it impossible to identify a ‘Buddy’ team mate because of the high source of glare generated by the other's headlamp or torch in the low levels of light often encountered. It is possible for a person to be temporally blinded when looking into a bright light after returning from an area with low levels of visibility. This loss of ‘Night Vision’ may result in placing one's self in additional danger.

A further complication is that it is often difficult for safety workers and others to identify their ‘Chain of Command’ leaders in poor ambient light or Vis versa. It is also desirable to be able to distinguish and differentiate between the different classes of safety workers on an emergency site. Better control and safety on an emergency site are essential needs. Further, it is imperative to easily locate or identify special designated areas, hazards, or a planned line of retreat. Essential tooling or plant maybe invisible or difficult to find on a disaster site in the masking atmospheres caused by smoke, chemical haze or other indistinct reasons. Additional obstacles also exist when trying to supervise the security of a site in low light. The simple identification of an authorised essential worker from other workers, victims or even non-suitable observers is vital.

Normal safety lanterns and large torches are cumbersome and unsuitable for many applications. Emergency vehicles are often well equipped with fixed and portable spotlights plus flashing, rotating or strobe style lights and light bars. Unfortunately, they may not be capable of getting their vehicle close to the scene of a disaster, or alternatively providing an essential early warning for other people. Flares and other forward warning signs are not always possible to use, because of high winds, fire risk, chemical or water hazards.

Other parties outside the site of activity, but still within the danger zone often need vital and more informative information. There exists a need for a very flexible, light and programmable message board, easily transported and simple to erect, with low energy requirements.

There is a need to improve the current methods of locating victims in marine emergencies particularly in poor light conditions, or a means to enhance the viability of using infrared and other detection equipment to further assist in such searches.

There is a need to provide a simple visual marker to assist with the evacuation of a burning premise without the complications and cost of a hard-wired emergency lighting system. Most existing domestic smoke detectors only provide an audio warning or a small internal light that has a limited area of illumination. The preferred mounting location for a smoke detector may not position the light in the most suitable position to provide suitable evacuation illumination.

There is a need to provide a more simple, robust, low energy consuming, very long life Traffic Lanterns with an ability to change shape, clearly indicate the time between signal changes and be more readily recognisable by vision impeded and colour blind users. Even the latest LED powered Traffic Lanterns still follow the tradition round lantern shape.

There is a need to provide an emergency worker with a safety vest or article of clothing or other means of personal identification that not only illuminates the worker to provide a visual identification for observers but also additionally incorporates a remotely activated personal tactile, audio, or visual warning signal. The warning signal maybe simply of one type or any combination of the three. The warning signal maybe manually activated remotely by a second party or automatically triggered to warn of an approaching danger that may not be visible to the worker. The danger maybe physically visible to people outside the area yet invisible to the emergency worker at his current position or it maybe detected by various automatic means that then generate a warning signal. This activated personal warning signal maybe visual, audio, and tactile or any combination within or on the emergency vest or article of safety wears.

There exists a need for fully recessed (flush) directionally illuminated road stud. Current road studs all project above the current road surface thus being subject to extreme impact damage from traffic. This impact causes wear that may move the stud from its original site or a reduction in its reflective properties. The ability to also signal a lane change, local danger and other temporary road conditions by illuminating the road markers is important.

Terms Used

An LED is a Light Emitting Diode. A simple Diode is used to control the flow of electricity to only one way in an electrical circuit An LED has a side effect that it produces light when electricity is flowing through it. The principles of LED's are known and depending on the materials selected, shapes and internal components they emit radiation wavelengths that cover the full spectrum of visible light, i.e. all the colours of the rainbow plus the invisible regions at either end namely Ultraviolet and Infrared. Vast varieties of LED's are available to suit many particular applications. These available LED's allow a wide choice of product by the variations in Colour Temperature, beam widths, sizes, light outputs and even mounting differences to help in the selection of the most suitable highly efficient LED for the required purpose. The most suitable colour wavelengths can be further tailored to suit the majority of common conditions encountered by a particular emergency service in their defined regular work. This selection is based on the needs for ‘mesopic vision’ (night vision/very low resolution and black and white only) and photopic vision (day vision).

LED's have many design characteristics over normal incandescent lights that further improve performance when powered by batteries. An LED increases its internal resistance when fed with less power and consequently operates slightly more efficiently. Thus they conserve the remaining energy in batteries weaken with prolonged use. An incandescent lamp just changes colour and fades much quicker.

The LED is also manufactured as an SMD (Surface Mounted Device) allowing even smaller packaging and its highly accurate placement on a PCB (Printed Circuit Board) by ‘Pick and Place’ machinery. This particular feature has allowed the applicant to develop unique solutions to some of the problems detailed below. The PCB is manufactured and worked to provide a stable but flexible base for the mounting of SMD LED's. The PCB can be contrived to provide a designated angle of mounting within a cover so that together with the selected beam width of a particular LED a very precise light distribution is obtained even when the PCB and cover have been made to follow or skin a non flat shape. This is very important in traffic lanterns and safety signals where very precise cut off viewing angles are required.

Statement of the Invention

In one aspect the invention provides a visual recognition and identification apparatus comprising a mounting means adapted for placement in a physical environment wherein said mounting means incorporates one or a plurality of light emitting diodes LED's adapted to provide a visual signal.

The mounting means may be an elongated flexible strip adapted for fixing to a range of substrates.

The mounting means maybe a badge or the like adapted to be worn on, over or attached to user clothing. The badge may contain a slim rechargeable lightweight high output battery connected to a flexible, shaped or bendable PCB. The PCB mounts a series of very small LED's designed to illuminate from the back (or rear projection), side or other suitable position a particular insignia or service patch or like identification, which is then visible to an observer in poor light when the Badge is activated. The circuit output is microprocessor controlled to pulse the LED's, or an alternating on/off switching mode or other programs or any combination of these. Appropriate electronic control gear is mounted either on the same flexible PCB or on one or more alternatively connected PCB boards. The totally self contained Illuminated Decal (hereafter referred to as ID) is designed to remain working and visible for at least the shift time an emergency worker would be allowed to be involved at an incident. The ID with integral or detachable battery is designed to be recharged and can be replaced to extend this time if desired. After the incident, the recharged ID is then available to refit to a new or cleaned emergency workers clothing as required.

As a further variation the ID maybe incorporated as a flexible moulding sewn into, bonded or otherwise incorporated within the physical making of the emergency worker's garment, vest, jacket, coat, harness and clothing. A further method includes mounting a portable ID strip by Velcro or other temporary means to a designated position on the safety wear. The ID is powered by an attachable rechargeable power pack (battery) incorporated in a pocket or other holding pod within the garment. Alternatively the ID with a battery maybe fully self-contained and provide mounting by clip, Velcro or other fastenings to a workers clothing or article of safety wear or equipment.

As an additional embellishment, the LED's may emit in the Ultraviolet wavelength rather than a wavelength of directly visible light. The outer cover is treated with fluorescent material and excited by the UV. A further variation uses additional Infrared-producing LED's to supplement or replace several or all of the normal visual light types. These Infrared producing LED's are visible only with the correct equipment and provide an identification code or other requirement for security purposes. Combinations of either two or all three types can be incorporated on the same circuit or on other individual or connected circuits.

In another aspect, the I.D. maybe shaped to follow an outline or skin of an inert object such as the door of an emergency vehicle. The ID draws current from the host vehicle's battery or separate power source.

In an alternative aspect, the SMD LED's maybe mounted either on one or both sides of a thin flexible PCB configured as a strip within a thin flexible protective cover. This cover maybe transparent or have a diffusing medium or combination of external finishing including silk screening or printed transparency. The outer cover maybe shape moulded with either an integrated lens, louvres and/or other mediums for controlling the directional output of the specialised light spread from the utilised LED's. Alternatively the light controlling mediums maybe located on separate items but attached externally or incorporated within the I.D. The flexible PCB maybe bent, indented, pressed, folded, machined, laminated, treated, pierced, or cut to a particular shape or otherwise worked to suit each particular application. This processing may provide a permanent physical alteration, allow increased flexibility or create an original or planned memory shape if required. The cover may incorporate attachment facilities by Velcro, magnetic strip, double sided tape, permanent mounting brackets, suitable adhesives or cable ties. The end caps or other outer parts may also incorporate a loop or hook to allow suspension.

In another aspect, the ID maybe a thin flexible tube containing a PCB, appropriate SMD LED's plus a microprocessor controlling circuitry, end caps and powered by rechargeable batteries. With the correct wiring, they can be hard wired to extra low voltage or extra low energy circuits. The PCB maybe flat or worked to allow very controlled beam angles when the tube and the attached components are bent or curved to suit a desired mounting configuration. The working of the PCB can be to provide a defined profile beam cut off angle or allow greater bending flexibility. These long thin units are given the name LIGHTFINGERS. LIGHTFINGERS maybe of various lengths and contain different numbers and types of LED's. Special end caps and joiner inserts plus additional electronics on the PCB(s) allow joining of multiple runs of LIGHTFINGERS. These runs can be in various planes and curved to follow a profile as required.

In another embodiment, the invention may incorporate a particular number and arrangement of SMD LED's to serve as a message board. All control of the electronics is by integral microprocessors The message board maybe pre-programmed with a simple number of messages, switched either from a remote location, or to deliver a live changeable message using a computer with suitable programming. The message LIGHTFINGER is designed to be powered by an extra low voltage external power source.

In an added embodiment of the invention, the LIGHTFINGER batteries maybe recharged by Solar or other renewable energy sources.

In a further aspect a simple LIGHTFINGER or ID maybe switched by an external audio signal either within a normal human hearing range such as the generated noise from an activated domestic type smoke detector, or outside human hearing ranges to avoid detection when required. A further switching could be by a remote infrared transmitter to an incorporated infrared receiver or other wireless transmissions and reception.

An alternative use allows the LIGHTFINGER or ID switching by an automatic detector incorporated within the basic unit or with a detector located in an appropriate separate location The LED's which are normally of the high output visual types maybe substituted with infrared emitting LED's when appropriate to allow use as stealth mode indicators for security use.

In another embellishment, The LIGHTFINGER or ID may also be located at, affixed or placed in a suitable location to visually mark a hazard or tool. Different visual description provided by the choice of suitable colours, widths of beams, control including a pulsing or static output and the general configuration and number of the LEDS on the PCB or overall shape of the LIGHTFINGER or ID.

A further enhancement of LIGHTFINGER maybe encased in a specialised outer water and pressure proof cover to allow its use under water or for added protection in varying dangerous conditions of use with hazardous materials or extra heavy duty applications.

A further function uses a specialised LIGHTFINGER for marine rescue. The LED's maybe visual, ultraviolet or infrared types or any combination. The PCB and cover return to an original memory shape to float when released from a storage shell. Another adaptation bends a special LIGHTFINGER either around a power pole or down the pole or as a combination of both and yet retains a defined beam angle and clear controlled visual cut offs. This flexibility with controlled cut off angles allows new versatile designs for traffic signals with increased mounting adaptability and extremely long maintenance periods. The traditional round lantern lens can be replaced with more versatile designs that do not required heavy lantern bodies, extensive louvers and hoods to provide cut off angles or combat sun phantom problems.

The ‘round the pole’ display may have distinctive facets to provide an observer at the designated viewing angle with a single colour traditional round traffic lantern type display. Other viewers at different viewing positions see another coloured traditional type round face. These round lantern typefaces provide different messages by way of colour such as Green (to go) in one direct whilst a facing Red lantern face stops traffic in another direction. Thus ‘one round the pole’ display can replace multiple lanterns. A single display band maybe used to replace a traditional 3-lantern aspect (Red, Amber, Green) The LED's are of the RGB type that allow changeable colour displays. Alternatively single bands maybe combined to provide a traditional 3-lantern type aspect. The top band Red, a middle band Amber and the bottom band Green, further bands or display inserts maybe illustrate arrows, ped crossings messages or even emergency vehicle warnings. In addition instead of the tradition round face other very clear distinctive recognisable shapes such as a square, diamond, triangle may replace or supplement the standard round display. This very visual display will greatly assist people suffering from limited vision or colour blindness to use Traffic Lantern controlled intersections. Furthermore the flexible display medium of LED's can provide a time down or moving visual indication of changing times between cycles. This time maybe illustrated by a progressive colour change between the traditional distinctive signal colours. The Red display slowly changes to amber to indicate the time left, the green may slowly appear to creep off the face and be replaced by an amber tinged green to emphasise the approaching Amber warning phase or other programmable alternatives. A further embellishment would be an additional boarder, shape or other visual indication within the lantern combination switched remotely by an emergency vehicle warning of its imminent arrival in the intersection. Further, audio warnings could be included on part of the new PCB.

A further need exists for a completely recessed intelligent road marker to replace the raised traffic control studs currently used. The markers top is flush with the existing road surface and allows adaptable traffic lane control or to provide an illuminated hazard warning.

In another aspect the invention provides a visual recognition and identification apparatus comprising a mounting means adapted for placement in a physical environment wherein said mounting means incorporates one or a plurality of light emitting diodes adapted to provide a visual signal characterised in that said LED's are mounted in a printed circuit board.

Accordingly, in further aspects the invention provides a badge, clothing accessory, clothing patch, animal collar, emergency warning device, fire alarm system, message board, road or rail warning system and a point of sale message board all characterised in incorporating the apparatus as previously described.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DETAILED DESCRIPTION OF THE INVENTION

The invention will now be discussed in detail by reference to the following Figures and Legend:

### Legend

### Summary of Numbers Used to Illustrate Drawings

Number Description

1 Surface Mounted (SMD) high performance LED's
2 Flexible PCB board mounting selected electronic control components. Maybe pressed, cut, folded, treated, laminated or any combination to improve flexibility.
3 Protective but flexible outer cover, clear, coloured, or with internal coatings. Maybe finished to diffuse, direct, colour, fluoresce or otherwise alter the LED's light
4 Possible mounting methods: Magnetic tape, Velcro, double sided tape, Adhesive backing, clip or hook or other means
5 Possible base profile of cover (3) to allow invisible mounting
6 Basic lineal component of LIGHTFINGER, consists of
   (1) LED's
   (2) PCB with electric components to suit application
   (3) Cover
7 End caps containing rechargeable battery or connections for hard wiring.
8 Live end with quick fit connectors for hard wiring.
9 Dead end caps, maybe fitted with mounting ring or holding hook.
10 Flexible joiner with wiring connecting 2 or more LIGHTFINGERS together.
11 Live end with battery and remote controlled switching
12 Live end with power pack and remote switching facility.
13 Battery power pack shown inside clip
14 CLIP ON ID Illuminated identification Badge. (ID=Illuminated Decal)
15 Cover of an ID maybe moulded, silk screened, transfer or other representation.
16 Rank identification: bands, colours, or badge etc
17 Another style of ID: SLIP ON type
18 Flexible PCB board with LED's, electronic components in a flexible cover Sewn-in, bonded or otherwise affixed to clothing or material. Waterproof
19 Coat, Jacket or Work shirt
20 Possible mounting methods: Magnetic tape, Velcro, double sided tape, Adhesive backing, clip or hook or other means
21 Shirt, light jacket or other outer garments or hazard protective clothing
22 Sewn in, bonded or mounted I.D.
23 Shoulder Flaps on shirt, jacket, coat or hazard protection garment
24 A complete LIGHTFINGER composed of
   (1) LED's,
   (2) Flexible PCB, with electronic components
   (3) Flexible cover
   (7) Live end with rechargeable battery pack,
   and (9) dead-end cover.
25 A waterproof pressurised outer cover for use by sea salvage or other specialised needs
26 Doorjamb
27 Hazards: Hole, Chemical spills, debris, dangers or Depot: Extra tools etc.
28 Water pipe
29 Tripod
30 Safety Cones
31 Safety Chain between Cones
32 Roadside picket or pole
33 Tree branch
34 Motor vehicle at accident scene
35 LIGHTFINGER hard wired into outer door rubbing strip or vehicle profile
36 Car Door
37 Emergency Vehicle
38 Another style of ID: SLIP ON type
39 ID shown on door of emergency vehicle (hard wired)
40 ID incorporated as a surround or fill in around number plate
41 LIGHTFINGER mounted outside to the profile of the curved rear window
42 LIGHTFINGER mounted inside to the profile of the curved windscreen
43 LIGHTFINGER configured as a flexible message board behind windscreen.
44 Clip on I.D. to car door, electrical connection from easy plug under mirror
45 Fold out LIGHTFINGER flexible message board
46 LIGHTFINGER message shown in a curved closed position then extended
47 Police Bike with extended LIGHTFINGER message board
48 Water Rescue tube containing
   (49) Very thin special memorised and shaped LIGHTFINGER
   (7) Battery Pack to suit application requirements
   Case may also contain marking dies, streamers or foil strips
49 Very thin special shape memorised LIGHTFINGER with either
   (1) SMD VISUAL LED's or
   (50) SMD INFRARED LED's or
   (50) & (1) LED's in combination
50 SMD INFRARED LED's
   These could also be special frequency emitting LED's such as in the X band
51 Sea surface
52 Smoke detector with Audio Alarm signal
53 Audio signal representation
54 Power Point
55 Small LIGHTFINGER, double sided tape mount.
56 Connecting lead
57 Cover of ID. maybe moulded, silk screened, transfer or other representation.
58 Remote switcher for (57) LIGHTFINGER. Infrared, audio or other methods. Stealth
59 Another style of ID: SLIP ON type
60 Recharging connections
61 Finishes to LIGHTFINGER: Reflective material
62 Finishes to LIGHTFINGER: lens moulding
63 Finishes to LIGHTFINGER: Silk screening, embossed, moulded, transfer etc
64 Finishes to LIGHTFINGER: diffuser finish to material
65 LED's arranged behind ID's skin to show number, letter or other recognition (See sheet 21 for possible arrangements.)
66 Special LIGHTFINGER with angled lenses, hard wired, flush mounted in road
67 Pedestrian Crossing
68 Road surface
69 Special LIGHTFINGER used as a Pedestrian Crossing signal wrapped around Possible mounting methods: Magnetic tape, Velcro, double sided tape, Adhesive backing, clip or hook or other means
70 Power Pole
71 Representation of standing Pedestrian in RED LED's and/or red screening STOP
72 Representation of GREEN LED's to represent a round signal lamp. GO
73 Representation of RED LED's to represent a round signal lamp. STOP
74 Representation of LED's to represent a round AMBER signal lamp. CAUTION
75 Representation of WALKING Pedestrian in LED's. AMBER light for caution
76 Representation of WALKING Pedestrian in GREEN LED's and/or green GO
77 External louvre maybe moulded in cover or separate.
78 Internal louvre maybe moulded in cover or separate.
79 Portable point of sale fixture comprising
   LIGHTFINGER message board
   Base with rechargeable battery or hard wired
80 Cover of ID. maybe moulded, silk screened, transfer or other representation.
81 Series of LIGHTFINGER together
82 Another style of ID: SLIP ON type
83 Pole viewed from rear
84 Moulding on cover to provide pin hole focusing
85 Moulding to provide a focusing shaft for the light from the LED.
86 Parallel faces of the mounted SMD LED's
87 Parallel cut off angles for the visible light from the SMD LED's
88 LIGHTFINGER mounted vertically to represent a conventional traffic Lantern with the three traditional round lantern faces. Mounting direct to a power pole by mechanical clamp or adhesive
89 The same configuration as 88 but with additional warning lights
90 Light segments acting as warning lights activated by an approaching emergency vehicle Vehicle
91 The same configuration as 88 but with differently shaped signal lights To assist with additional identification and recognition
92 The same configuration as 88 but with continuous colour changes.
93 The red ‘STOP’ signal represented as a diamond shape
94 The yellow ‘CAUTION’ signal represented as a spiked circle
95 The green ‘GO’ signal represented as a soft rectangle.
96 Light segment of SMD LED's representing the red ‘STOP’ signal
97 Light segment of SMD LED's representing yellow ‘CAUTION’ signal
98 Light segment of SMD LED's representing green ‘GO’ signal
99 Spikes light first to give a warning of a light change. Could also be part of an approaching Emergency vehicle warning.
100 Extra segment of light bands that could be used to indicate time elapsed or configured to allow warning signal for approaching Emergency vehicle
101 ID moulded to fit dog collar or as a badge
102 Emergency Services Rescue Dog
103 RAIL CROSSING
104 Solar Panel
105 Storage for Battery & Switching gear
106 Hard wiring connections
107 Another form of personal I.D. removable shoulder flash
108 The enclosing sides are coloured to assist in recognition
109 The bottom of the illuminated badge projects coloured or white light to further improve i
110 Flexible message board affixed to the rear of a vehicles curved stone deflector Clip in flexible message panel. May indicate a different part of a message or a symbol.
111 Can be mounted to face rearwards or another direction to the base unit showing the main
112 Clip together LIGHTFINGER flexible message board (Panels).
113 Smoke alarm companion and emergency stand by light piggybacked over a power point
114 Smoke alarm companion recessed into wall cavity
115 Spring clips to hold in place and allow removal for battery change
116 Cover plate maybe have simple LEDs or a stylised symbol as the illuminating display
117 Flexible message type LIGHTFINGER wrapped around a hollow pole to create a 360-degree stand alone signal. The display may be:
   Conventional type round signal faces with very defined cut-off angles of viewing
   A full moving message including symbols
   Or a static colour display
118 Hollow pipe mounted vertically in the ground
119 Gear tray suspended within a hollow pipe carrying all control gear including rechargeable batteries, and remote switching facilities. The gear tray counterbalances the vertical mast and attachments
120 Control gear and all components to operate the wrap around light display.
121 Vandal and weatherproofed cap to seal all components within the pipe. The exception is an optional mast to carry attachments.
122 Mast to carry optional radio antennae or solar panel.
123 Solar panel. Unit may also be mains powered or even remote wind or water generation
124 Radio antennae for remote control.
125 Optional switch
126 Non removable triage band
127 Specialised use of a flexible light finger
128 Front of a safety vest with lightfingers
129 LIGHTFINGER configured to provide a short focal length hands free torch for the vest wearer
130 Activated tactile warning
131 Activated audio warning
132 Rear of vest showing lightfinger inserts

FIG. 1a A simple flexible very small strip PCB shown with surface mounted LED's. (SMD LED's)

FIG. 1b A possible covered PCB with SMD LED's. I.e. a LIGHTFINGER

FIG. 1c A possible profile to allow flush or hidden mountings for some uses of LIGHTFINGERS such as when it is semi permanently mounted as a simple the fire alarm emergency light way.

FIG. 1d The basic components used for a standard LIGHTFINGER.

Drawing 2

FIG. 2a The PCB maybe folded or pressed to shape. Always the mounting pads for the SMD LED are in the stress free sections of the PCB.

FIG. 2b The PCB maybe folded, pressed, slotted, cut or otherwise mechanically worked.

FIG. 2c The PCB maybe modified by a combination of several methods as discussed above or any other suitable means including chemical treatment, laminations or variations in thickness etc. To tightly control or modify the light beam angles from the selected LED's their base or connection pads on the PCB maybe worked to form a specified angle of mounting when the ID or LIGHTFINGER is bent to a predetermined profile. Critical application such as Traffic Signals require rigid cut off angles. This angle may place the emission faces of a designated number of SMD LED's parrel to each other or at a specified angle to each other when the LIGHTFINGER follows a curved shape,

FIG. 2d A basic PCB with SMD LED's shown from several angles

FIG. 2e The LED's mounted on a double-sided PCB.

FIG. 2g The LED's maybe angled to suit controlled light beam emission.

The SMD LED's follow the profile of the shape taken by the PCB; this is different to 2c where the PCB is ridged to keep the faces of the SMD LED's in the same direction. Faces are parallel.

Drawing 3

FIG. 3a An ID as a completely self-contained weatherproof unit containing battery, PCB with LED's and control gear with on off switch. Velcro, loop, hook or other mechanical means mounts the badge.

FIG. 3b An ID as a self contained illuminated Clip-On shoulder or pocket patch with rechargeable battery.

FIG. 3c Slip-On ID used on the button down shoulder flaps of Emergency workers clothing.

FIG. 3d Very flexible thin outer moulded or affixed within clothing joints, the rechargeable battery pack is stored in a pocket or pouch. The LED's can be of the UV-A emitting type that excite florescent or phosphor powders inside the outer cover to produce a continuous soft glowing piping. The emitted light maybe white or other selected colour.

Drawing 4

FIG. 4a Self contained ID with rechargeable battery attached as a shoulder patch. Attachment to clothing maybe by Velcro, Loop, or special pouch within the garment. Alternatively attached by mechanical means such as a hook, pin or loop.

FIG. 4b Self contained ID with rechargeable battery worn as headgear.

FIG. 4c Self contained ID with rechargeable battery attached as a pocket flap.

FIG. 4d A self contained LIGHTFINGER combined within a dog collar on a rescue dog. Alternatively, an ID may be attached as a pendent from the collar.

Drawing 5

FIG. 5a The back of a coat with an ID panel. The power source, a small rechargeable battery is held in a special pocket in the coat.

FIG. 5b Slip-On ID for shoulder flap use on shirts, jackets, coats or other suitable emergency apparel. The unit is self-contained a with rechargeable battery. Different configurations could be used on separate shoulders. E.g. left shoulder Police and the right shoulder their Rank to further assist identification.

FIG. 5c A very small LIGHTFINGER with special outer soft pliable profile allowing sewing or bonding into clothing or even a Safety Harness. The battery is held within a separate compartment or pouch. To obtain a soft glow the SMD LED's maybe of the Infrared type and the cover treated to fluoresce.

Drawing 6

FIG. 6a The outer case or cover of the LIGHTFINGER maybe finished in a variety of ways. Reflective materials, lens, etc for directional control or silk-screened, printed or even selective inner transparencies or partial transparency or diffusing finish.

FIG. 6b Two bendable LIGHTFINGER strips joined and wired by a flexible joint allowing mounting in all planes.

FIG. 6c Fully self contained LIGHTFINGER encased within a pressure protected and heavy duty outer for use in undersea salvage use or vary hazardous chemical spills that would damage a normal fitting.

FIG. 6d A view of a curved LIGHTFINGER in one plane

FIG. 6e A view of a modified PCB worked to allow curvature yet provide a firm base for the mounting of a SMD LED.

FIG. 6f Cross section of a curved PCB in a LIGHTFINGER allowing a broader light spread.

Drawing 7

Portable Rechargeable Lightfingers for Use in Hazard Conditions

FIG. 7a LIGHTFINGER on a door surround as a safety marker held by self adhesive tapes

FIG. 7b LIGHTFINGERs placed in strategic positions to mark hazard areas or strategic store areas or special tool dumps

FIG. 7c LIGHTFINGER hung as a warning of dangerous overhead projections.

FIG. 7d A LIGHTFINGER hung from a simple tripod. Very stable when used in heavy winds or poor conditions such as water over the road.

Drawing 8

Various applications of portable and rechargeable LIGHTFINGERs at an accident site. Apart from just being placed on the ground the LIGHTFINGER maybe hung, supported by clips, self-adhesive tape, magnetic stripping or fitted to a traditional emergency cone.

Drawing 9

FIG. 9a A LIGHTFINGER inserted as part of a vehicles rubbing strip.

FIG. 9b Profile illumination of an Emergency Vehicle by a series of flexible LIGHTFINGERs hard wired to the vehicles battery. Note a further refinement is to use SMD LED's emitting Ultraviolet preferably in the safe UV-A wavelengths. The outer cover is coated internally with florescent or phosphor materials to react and transmit visible light. I.e. glow in the dark. The vehicle's profile is clearly defined.

Drawing 10

FIG. 10a A LIGHTFINGER mounted behind a contoured wind deflector, waterproofed and hard wired.

FIG. 10b An ID mounted on the side door of a vehicle plus a LIGHTFINGER moulded or mounted as part of a protective rubbing strip.

FIG. 10c A specially moulded ID or LIGHTFINGER filling the numberplate surround. Use is made of an available commercial moulding used to differentiate between models by the original automobile manufacturer. In addition, a weatherproof LIGHTFINGER shown mounted externally to the contour of the back window.

FIG. 10d A LIGHTFINGER mounted behind and moulded to the profile of a vehicle's windscreen.

Drawing 11

FIG. 11a A LIGHTFINGER message board Velcro mounted on the vehicle's sun visor (s). The flexible message board follows the internal contour of the sun visor. The rear vision mirror splits the LIGHTFINGER message screen. A message can continue across both segments as one continuos message or provide two separate messages pads. The sun visor (s) fold down to provide a better viewing angle when operating.

Drawing 12

FIG. 12a Application of a skin shaped ID that can be semi permanently mounted to the door of a selected vehicle. The power can be supplied by wiring a simple connection from the base of the external mirror or other means. The ID maybe held by magnetic mounts and clips or mounted by a more permanent means.

FIG. 12b A LIGHTFINGER message board that normally carries the message face against the door skin for protection but is folded out or reversed when required to show a message. A message is selected from a collection of pre-programmed messages accessed by a numerical keyboard (in vehicle) or by connection to live programming by lap-top or an audio signal from a central command. The circuitry is designed to suit the required source.

FIG. 12c View from above of a LIGHTFINGER message board shown secured around a circular fixture for storage, then opened and supported.

FIG. 12d The LIGHTFINGER message board extended and stabilised on the rear of a stationery police bike.

FIG. 12e The LIGHTFINGER message board maybe folded in a variety of ways or detached for ease of carrying and storage. Folded out or clipped together panels of a segmented LIGHTFINGER message board. The messages flows across all panels or alternatively provide separate messages on single segments.

Drawing 13

FIG. 13a Fold out LIGHTFINGER message board for external power supply. Designed as a simple storage case when folded for ease of carrying and protection. Maybe mounted on a tripod or by other methods to improve visibility. The messages can be pre-programmed and simply displayed by number selection, changed with a lap-top live program on site, or with suitable equipment maybe controlled remotely. Panels maybe folded or unclipped for storage. Panels maybe attached at the top or bottom of the central panel as well as the sides.

Drawing 14

Special version of a LIGHTFINGER designed for Marine Rescue.

FIGS. 14a-f Shows a closed capsule containing a spiral stored LIGHTFINGER treated to return to its original flat state and float on the water surface when released. An alternative allows the LIGHTFINGER (LED's mounted double sided) to stand up as a visible beacon. The release also turns on the LED's. An internal battery powers the LIGHTFINGER. The packaging may also contain streamers, soluble dies, foils or other items to further aid visual or other means of detection. The LED's may be the normal visible light producing type or infrared or selected to emit in another specialised wave band or a mixture depending on requirements. A specialised Search and Rescue detection unit could specify an actual emission wavelength for greater identification.

Drawing 15

FIG. 15a A special version of a LIGHTFINGER for use with normal domestic type smoke detectors. Very fine, clear covered LIGHTFINGER with battery and audio switch tuned to the audio output of an existing smoke alarm. The audio signal activates the LIGHTFINGER strip without any wired connections between the detector and the LIGHTFINGER. Alternatively a RF switch in the LIGHTFINGER maybe triggered by a wireless RF generator in or attached to a smoke alarm when activated by smoke. Other wireless switching systems such as infrared maybe used. A further enhancement maybe the provision of a solar cell and recharging circuitry to increase the life of the battery.

FIG. 15b A similar special LIGHTFINGER with flexible wiring from a power pack (including a rechargeable battery) permanently plugged into a GPO. This unit is activated by the audio output of the smoke alarm during a fire, or by the loss of power in the host circuit. It remains on stand by at all times. The unit triggers ON during a power failure to act as an emergency light way marker. Simple D.I.Y. installation.

The LIGHTFINGER is very thin, clear covered and mounted by non-visible self adhesive tape to allow unobtrusive placement along architraves, window frames or door surrounds etc.

FIG. 15c A similar special LIGHTFINGER designed to piggy back a normal GPO power pack. The unit allows normal use as a power point the pass through connections maintaining the rechargeable battery. This unit is activated by the audio output of the smoke alarm during a fire, or by the loss of power in the host circuit. It remains on stand by at all times. The unit triggers ON during a power failure to act as an emergency light or pathway marker. In a variation the light output maybe directional Simple D.I.Y. installation.

FIG. 15d A similar special LIGHTFINGER but recessed into a hollow wall cavity all wiring including a simple battery are behind a small front plate. The unit is held in place by spring clips or other means to allow simple removal for battery replacement. This unit operates in a similar method and is activated by the external signal from the smoke alarm during a fire. The front plate lights to provide an emergency light way marker. Simple D.I.Y. installation.

Drawing 16

FIG. 16a A special small version of a waterproof LIGHTFINGER for outdoor use as a pathway guide or for military force use. The LEDs maybe normal or infrared types. The self-contained units maybe used singularly or in groups and activated by remote control. The cover maybe camouflaged to hide in a garden or other areas. A recharging solar cell may form part of the unit.

FIG. 16b An ID design showing how the LED's maybe used to either just backlight the badge or further provide a hidden marker (shown as a P) for additional identification or extra security. The LED's defining the symbol (in this case the P) are infrared and only visible to people with special infrared viewing equipment such as on site security.

Drawing 17

FIGS. 17a-b Specialised road use of a flat faced fully recessed LIGHTFINGER directionally straight to the line of sight of an approaching vehicle driver. Note the distinct angle of light beam emission from the PCB LED's defined by the slanting PCB and flat outer cover. Light emission could be sideways or other defined directions. Simple installation using road marker adhesive and regular road cutting procedures ensure minimal disturbance to the road surface. Wiring maybe normal hard wire connections or by non contact induction loop buried within the road.

FIG. 17c A series of LIGHTFINGERs defining a rail crossing powered by storage batteries charged by solar power. The control gear also includes a switching receiver or remote track mounted hard-wired switch. The LED display maybe static or pulsing. The approaching train's transponder switches the LIGHTFINGERs on at a safe distance before the crossing. Other source of power maybe used. The LIGHTFINGERs are arranged in the road to show a Crossing (X) but other symbols can be mounted on a designated vertical service, including wrapping around the warning pole(s).

Drawing 18

FIG. 18a Shows a specialised use for LIGHTFINGER as a Pedestrian Lantern. Three rows of LIGHTFINGERs fitted around a power pole (round) or other suitable vertical structure. The PCB has been processed to provide four very distinct images with strong defined cut off angles, so that only one image is visible at any viewing angle to the pole. There are four images facing the four corners of the compass. If we assume traffic to be travelling north south then the images facing north and south would be the traditional round lantern face. The east and west images would then direct pedestrian behaviour at the crossing. There is an opportunity to use different symbols if required.

It is possible to use just one LIGHTFINGER and change the colours and figures by rotation (circuit only not physical) to provide crossing discipline.

Drawing 19

FIG. 19a The directional light output characteristic of SMD LED's maybe further enhanced by bending the PCB to a defined angle to suit the application.

FIG. 19b The ultimate light output from the LED's (1) maybe redirected or modified by a lens (62) moulded or machined or otherwise worked as part of the outer cover

FIG. 19c The light output from the LED (1) maybe modified by

A diffusing medium (6): moulded, silk screened an insert of diffusing material or otherwise worked as part of the outer cover.

A lens (62), Directional, Spot, Flood or defined angle of focus. Clear or coloured.

A Pin Hole Focusing (84) by moulding or screening.

A moulded light shaft in the cover (85) to shape the beam.

Internal Louvers or Baffles (78).

External Louvers or Baffles (77).

Drawing 20

FIG. 20a Possible POINT OF SALE unit. Rechargeable base and LIGHTFINGER message strip. Message programmable as required.

FIG. 20b LIGHTFINGER message strip showing it wrapped around a pole at an angle to the perpendicular, but programmed to present the message in a normal vertical text.

FIG. 20c Simple LIGHTFINGER message strip maybe enlarged by the addition of extra strips and programmed together.

Drawing 21

FIG. 21a-b Simple LIGHTFINGER message strip wrapped around a capped hollow vertical pipe where the internal cavity is used to completely contain all the electronics, batteries and other components to allow it to operate as a stand alone traffic lantern. The unit maybe used singularly or in groups. Power maybe by mains or optional solar panel or alternative power generation.

The unit may be controlled directly by conventional PED switch or a key operated switch or remote wireless or hard wired control.

Other traffic hardware devices maybe fitted to the optional mast such as traffic type radar and the required electronics enclosed within the body

FIG. 21c A very simple use of a LIGHTFINGER incorporated as a triage illuminated marker. The band is wrapped and secured around a patient's limb at an incident site and a colour or combination of colours activated. There maybe one LED only or several. The colour maybe created by the initial colour of the selected LED or by an adjustable multicoloured lens. The control once activate cannot be reset and the band is removed when the patient reaches external care. An optional voice chip or other readable markers maybe used to allow the initial diagnostic opinion to be available to the extracting emergency workers etc

FIG. 21d A safety vest with lightfinger sections embedded. The front section has them configured to provide a short focal length torch

FIG. 21e The safety vest has a remotely triggered tactile warning

FIG. 21f The safety vest has a remotely triggered audio warning

FIG. 21e The safety vest rear showing lightfinger sections.

Drawing 22

FIG. 22a A flat PCB with LED's showing the cut off angles of generated light.

FIG. 22b An altered PCB bent around a curved surface with the LED's positioned to have their faces parallel to each other and hence reproduce the original cut off beam angles.

FIG. 22c Examples showing how altering the PCB shape from flat to concave or convex curves changes the defined cut off angles of light emission from SMD LED's.

Drawing 23

FIG. 23a An example of a LIGHTFINGER mounted vertically as a Traffic Signal 3 gang Lantern. The light output is design to reproduce the conventional round signal lens. The PCB has been worked to reproduce the required cut off angles even though it has been curved to the pole profile.

FIG. 23b The same configuration as in FIG. 23a but with an additional pair of light strips that can be activated by an approaching Emergency vehicle to further improve road safety.

Drawing 24

FIG. 24a The same basic layout as in FIG. 23a except that the SMD LED's are configured to show three distinct shapes to assist with visual identification particularly by those with colour blindness. There is no need to retain the round lens style of conventional Traffic Signal Lens as there is no single centrally mounted incandescent lamp requiring specialised lens, shrouds etc to obtain a desired cut off angle.

The central yellow CAUTION section has spikes that could shrink as a time change countdown indicator.

FIG. 24b A further idea for a Traffic Signal Lantern. The shape could allow light creep age down the LIGHTFINGER to show the approaching signal change.

### DETAILED DESCRIPTION OF THE INVENTION

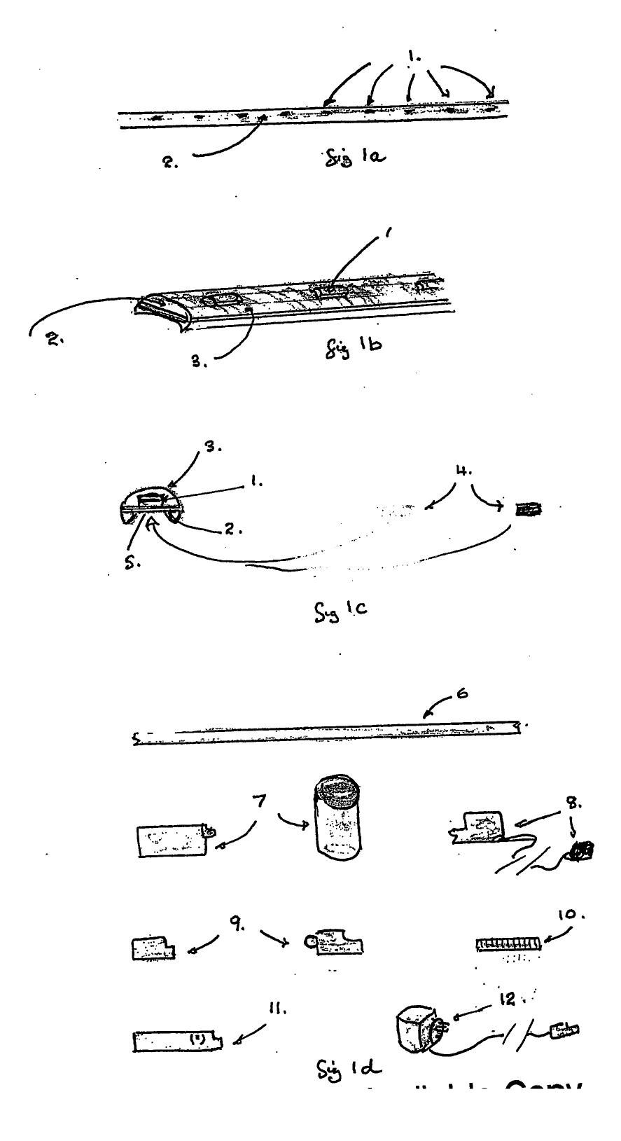

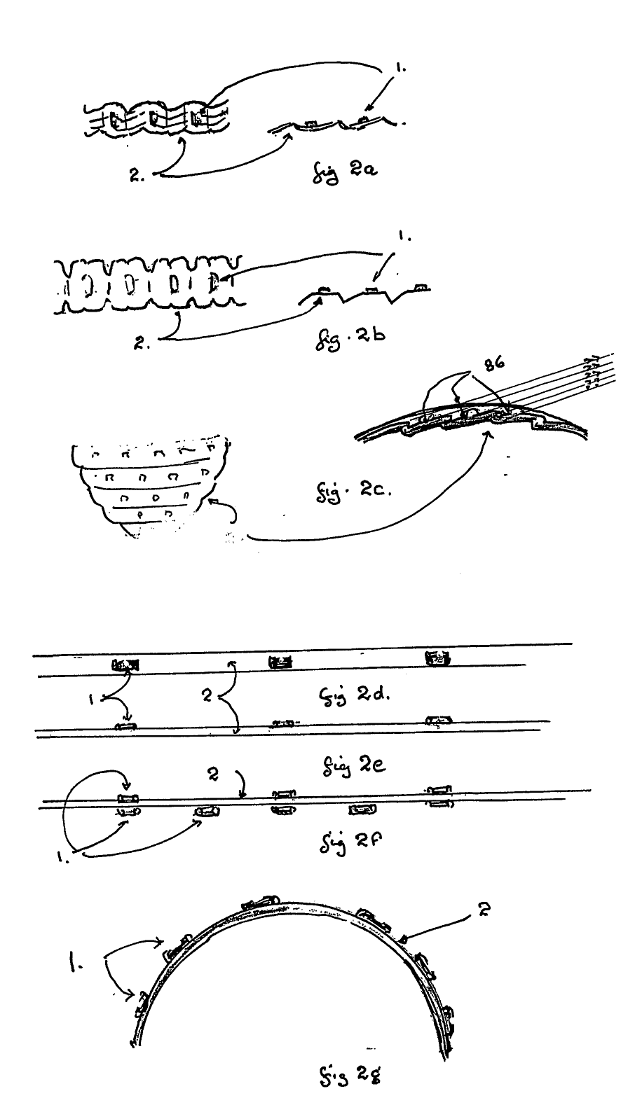

Referring firstly to FIGS. 1, 2 and 3, the invention may take the form of an elongate and flexible apparatus comprising a mounting means in the form of a flexible printed circuit board PCB 2 having positioned along the length thereof a plurality of light emitting diodes 1 in the form of a plurality of surface mounted devices SMD. A battery or other means may power the light emitting diodes LED's.

The visual recognition and identification apparatus of the invention provides a highly compact image or signal generating device relying on light emitting diodes as the signal generating means, where the light emitting diodes are mounted or supported directly onto a flexible and compliant printed circuit board. In this manner, the apparatus of the invention provides for the first time, a compact, compliant, flexible apparatus for emitting a signal including a visual signal, in a form that can be readily adapted to a wide range of applications, due to the compact lightweight and particularly flexible and compliant nature of the apparatus.

In particular, the compact nature of the apparatus allows the use of microchips or microprocessors which can be incorporated into the printed circuit boards for programmable controlling and operation of the LED's. In this manner, the complete apparatus can be presented in the form of lightweight, flexible, low energy demanding units that find wide application in a variety of situations, as will be described with reference to the further figures.

In the first preferred application of the apparatus of the invention, the apparatus takes the form of an elongate highly flexible, very compact strip with a plurality of service mounted, light emitting diodes as shown in FIG. 1a. In another embodiment shown in FIG. 1b, the printed circuit board, functioning as a mounting means, can be provided with a cover 3 in order to provide protective functions. The cover can also provide various colour indications, fluorescents, or other means to adjust the LED's output. The cover can also be filled with a clear or opaque filler, for example, silicone fillers provide a surprising enhancement of the visual features of the apparatus.

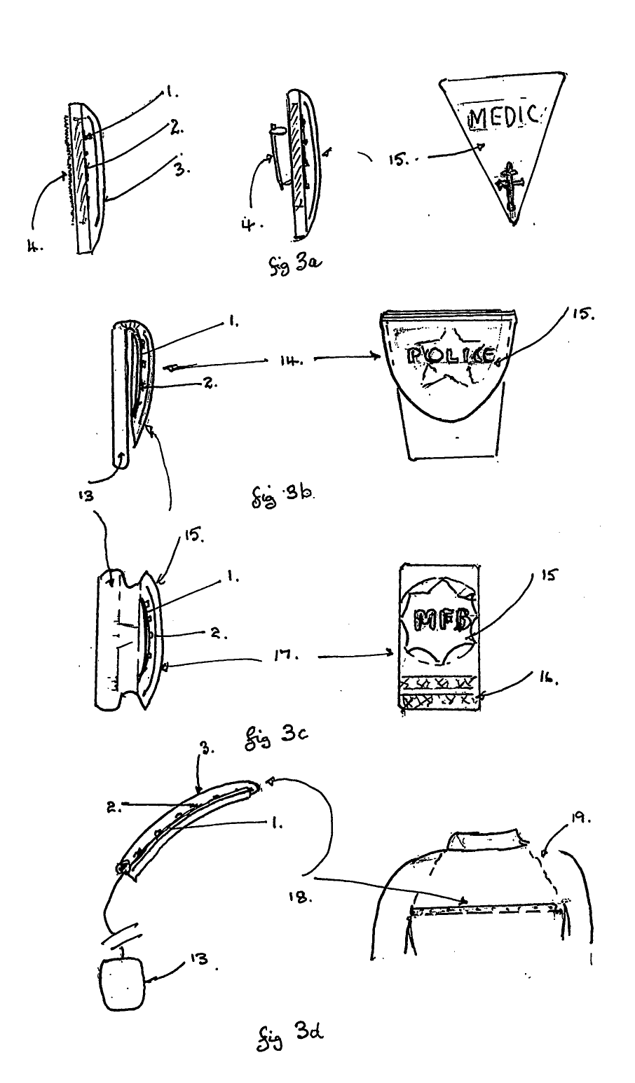

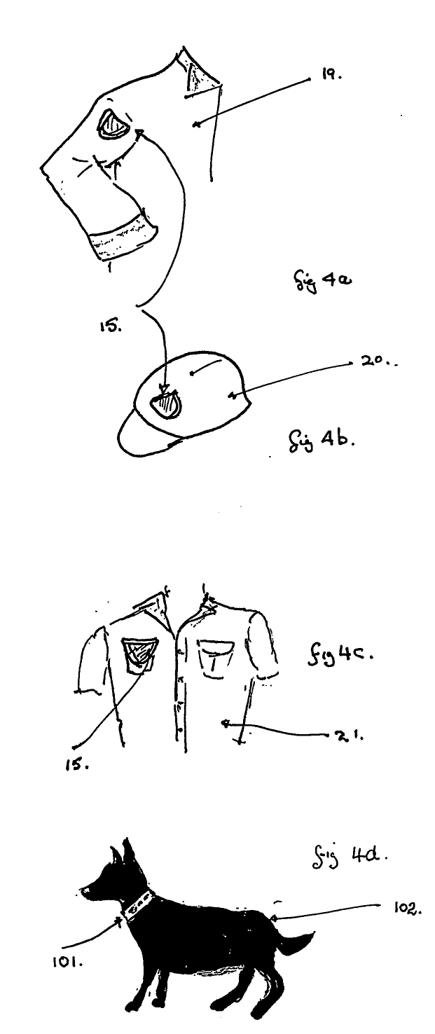

Referring now to FIGS. 2a to 2f, other physical formations of the apparatus of the invention is shown, where the printed circuit board can utilise its compliance and flexibility to be pressed or formed into particular shapes as required or preferred for select applications.

In this form, the apparatus of the invention provides a highly versatile illuminated device, which can be readily adapted and placed in a variety of physical situations to provide visual recognition and identification as required.

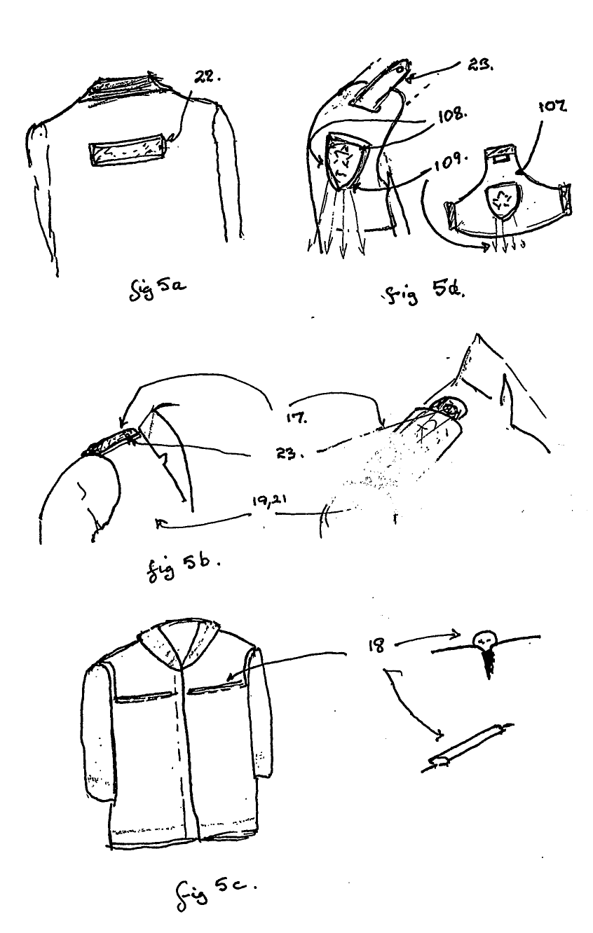

Referring now to FIGS. 3 to 5, the apparatus of the invention is shown as applied to a badge which is adapted for placement on a users clothing. The badge incorporates a plurality of LED's, which again can be powered from a modest battery pack. In this mode, the invention provides a ready means of identification personnel and a range of situations. E.g., fireman, ambulance drivers, police etc can readily identified notwithstanding low light situations and other hazardous environments.

Referring firstly to FIG. 3a, a totally self-contained device in the form of a badge for wearing by a user is shown, where the unit includes a number of LED's 1 mounted on a printed circuit board 2 and provided with a protective cover 3. The whole unit can be provided with a suitable fixing system 4, which can take various forms including velcro type fasteners, clips etc. FIG. 3b shows a clip on version of the same badge and FIG. 3c shows a slip-on version of the similar unit.

Referring now to FIG. 3d, the full versatility of the apparatus of the invention can be demonstrated when the invention takes the form of an elongate lightweight highly compliant and flexible strip, with a remote power pack 13. The apparatus in this form is readily stitched into or applied to a wearers clothing 19. As such, the wearer can now become highly visible by way of the light emitting diodes, which can be activated by the power pack, as a continuous emission of light. Alternatively, the light emitting diodes could be pulsed or programmed for activation according to particular circumstances. For example, an emergency worker may required sudden instruction, which could be remotely indicated via the apparatus of the invention.

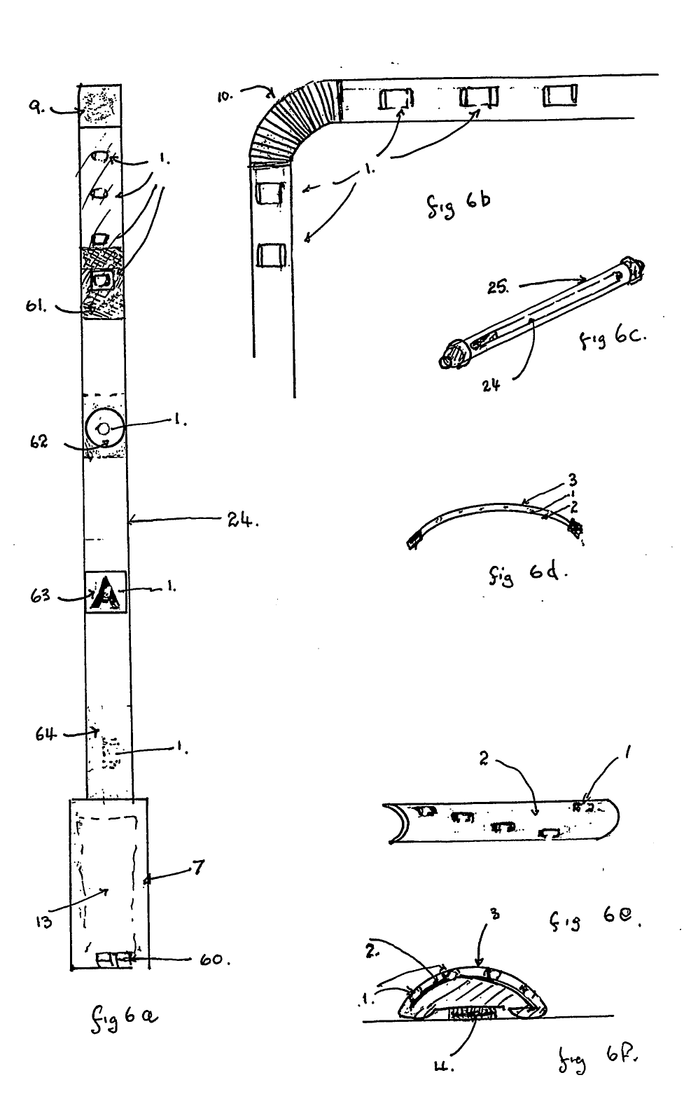

FIGS. 4a and 4b show alternative applications of the apparatus of the invention when applied in the form of a badge, where FIG. 4a shows the badge applied as a shoulder patch and FIG. 4b shows the badge applied as a cap patch.

FIG. 4c shows application to a pocket of a wearers clothing 21.

Another embodiment of the invention finds application with the apparatus being applied to a dog collar 101. Such an application, will allow an emergency services rescue dog 102 to become highly visible in situations where smoke or fumes may visually obstruct the presence of such a rescue animal.

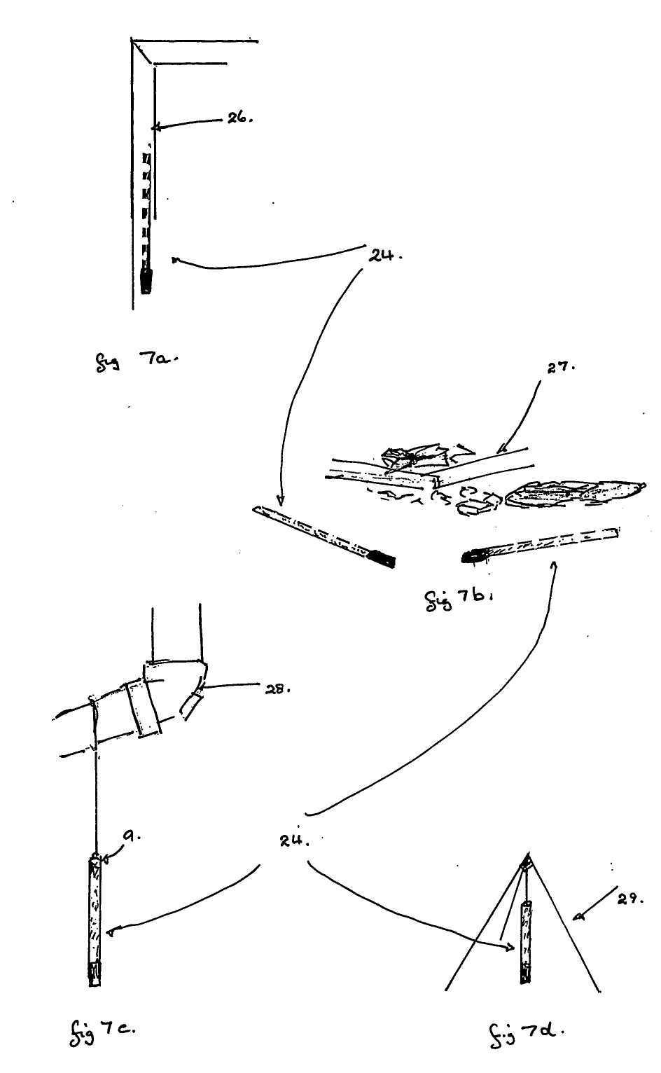

Referring now to FIGS. 5a-c, other applications of the invention are shown, where this form of the invention can be sewn on 22 to a piece of clothing. FIG. 5b shows the unit being applied to the shoulder flaps 23 of a piece of apparel 19, 21. FIG. 5c again demonstrates the high level of versatility of the invention where very lightweight compliant soft and flexible apparatus of the invention allows one of the units to be readily sewed or bonded into a piece of clothing, including safety harnesses etc.

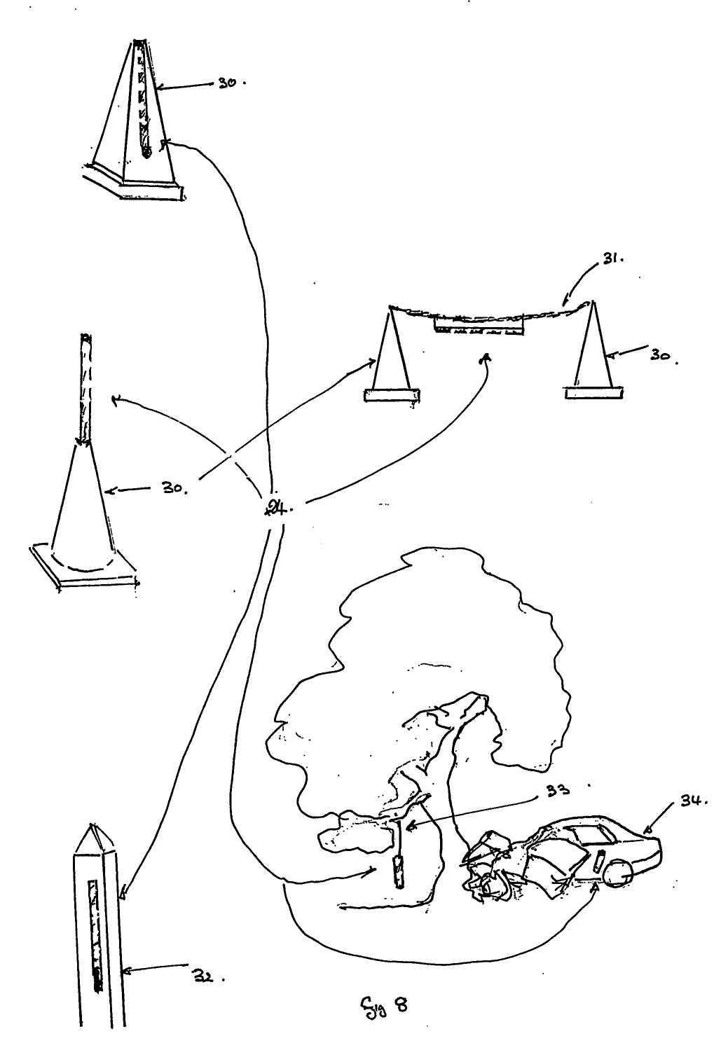

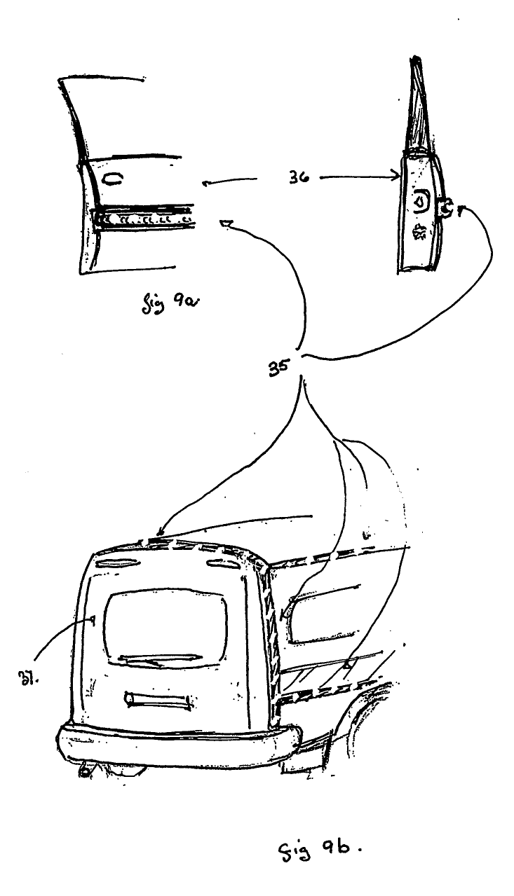

Referring now to FIGS. 6,7, and 8, various alternative embodiments of the invention are shown where the apparatus of the invention can be adapted for a wide range of applications. Referring to FIG. 6 the invention provides a variety of markings and the ability to be bent in several planes and joined for continuous runs. The high level of flexibility is again clearly demonstrated in this particular embodiment where the mounting means in the form of a flexible and compliant printed circuit board, allows the apparatus to be bent in a variety of planes and different directions, so as to provide continuous and uninterrupted visual displays over a wide range of physical situations. Referring firstly to FIG. 6a, the apparatus of the invention can be finished in a variety of ways, including reflective materials, lenses etc, which provide for directional control and a wide range of possible visual indications as appropriate. FIG. 6b shows two flexible elongate strips including the apparatus of the invention, where a flexible joiner 10 can be used to connect to strip formations of the invention. FIG. 6c shows the invention in the form of a sealed tube 24, 25. FIG. 6d shows the ability of the apparatus of the invention to be curved in a first plane. FIG. 6e shows the ability of the apparatus of the invention to be curved in a second plane. FIG. 6e shows the apparatus of the invention being curved in a first plane so as to provide a secure mounting and footprint for the application of a range of fixing means 4.

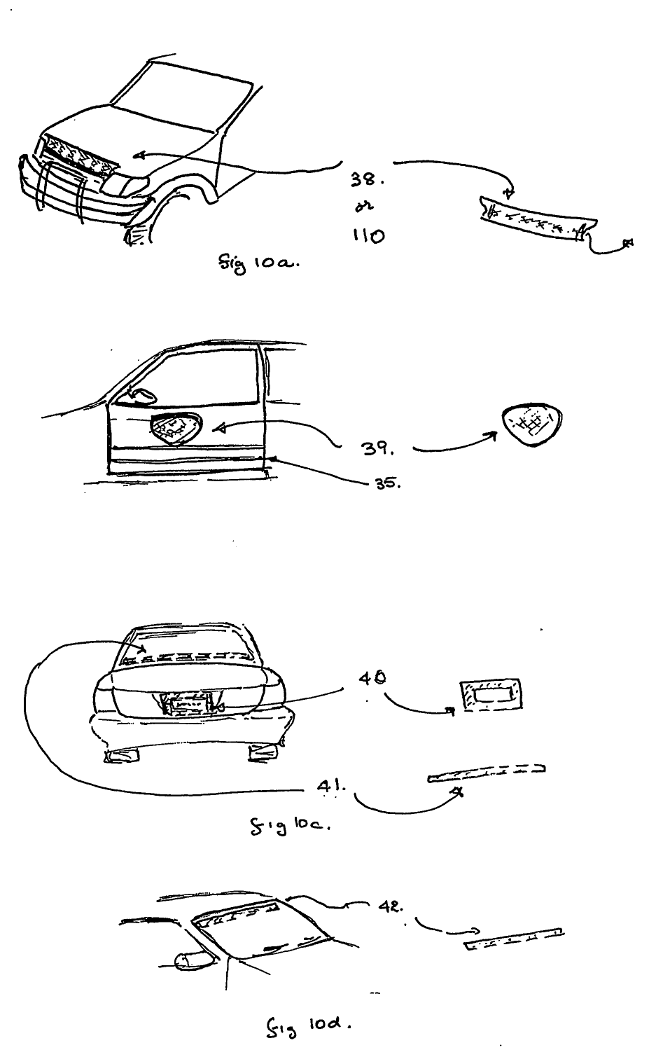

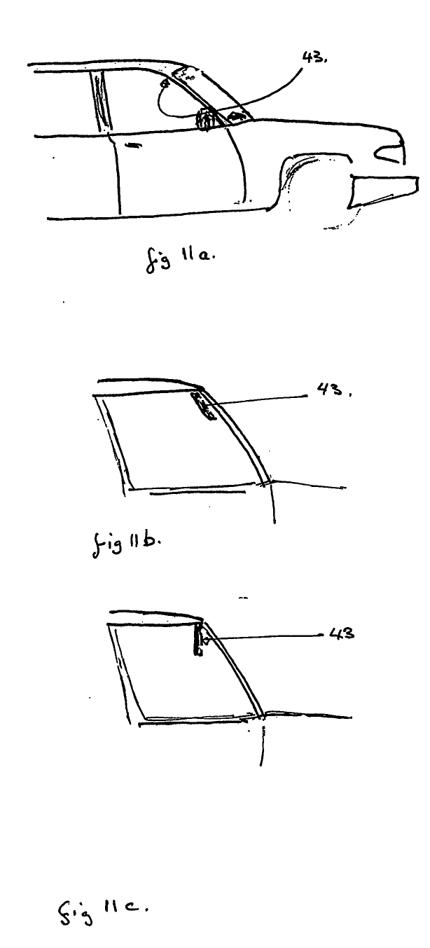

Referring now to FIG. 7, the apparatus of the invention can be applied to the manufacture of a wide range of safety and hazard reduction devices. The invention can provide a warning device for identifying a number of situations in an industrial environment where pipes, conduits and any number of hazardous situations may need to be readily and unambiguously identified by safety service personnel. This adaptation provides a particular application where the apparatus of the invention can be configured as an integral unit having a mounting means provided with a plurality of light emitting diodes and an integral battery power pack. Such devices are lightweight, robust and capable emitting sufficient light over a long period of time to provide the necessary identification of the hazardous site or critical staging area or specialised tool dump or other significant areas requiring ready identification by safety workers. Referring firstly to FIG. 7a, the invention can be applied as a strip formation for application around the architraves of a door or window. In this manner, particular parts of a building can be readily identified for quick exit, or alternatively, can identify a hazard. FIG. 7b shows the situation where an identified hazard 27 can be delineated and cordoned off by the placement of an emergency warning device 24 including the apparatus of the invention. FIG. 7c shows similar device being attached to a water pipe 28 identified as a hazard. FIG. 7d shows being used within a tripod, again for ready identification of a hazardous situation. Referring now to FIG. 8, the invention provides apparatus well adapted for use in an urgency situation or accident site. Referring to the various examples shown in FIG. 8, the apparatus of the invention finds application for the manufacture of a wide range of hazard reduction devices which can be applied to hazard or other warning situations including safety cones 30, which can incorporate the apparatus of the invention. Safety chains strung between cones or other situations 31. Roadside pickets or poles 32, can be provided with such an apparatus, and the apparatus can be applied to motor vehicles or other accident situations 34, by application to the vehicle itself or a tree branch 33.

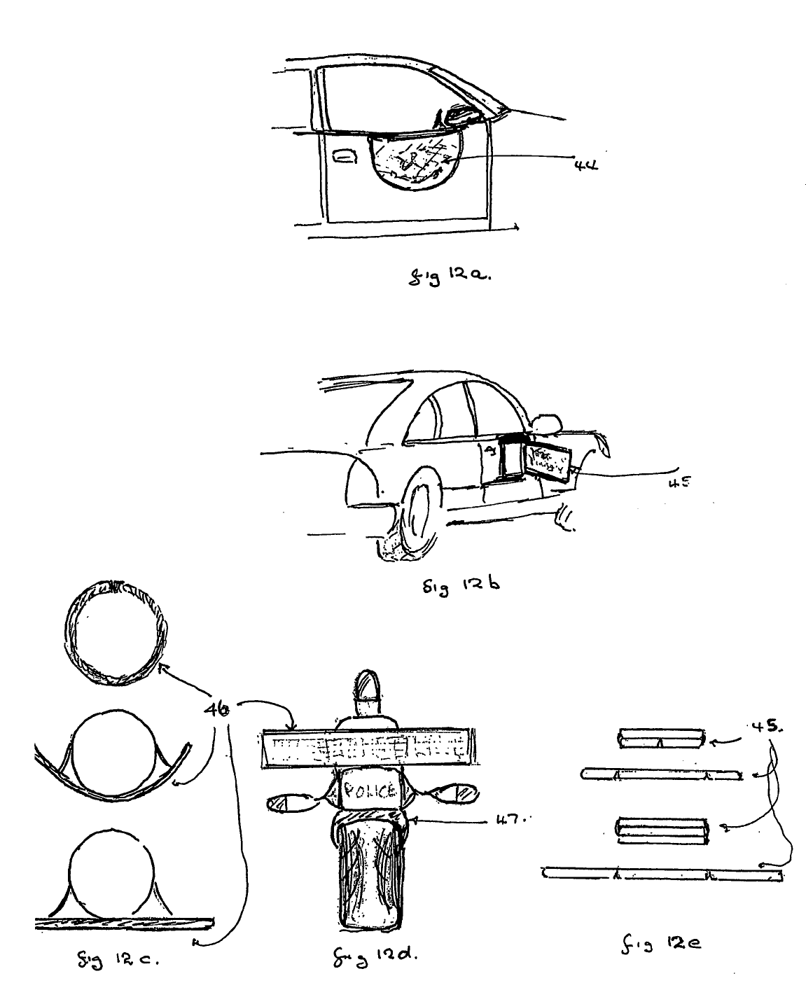

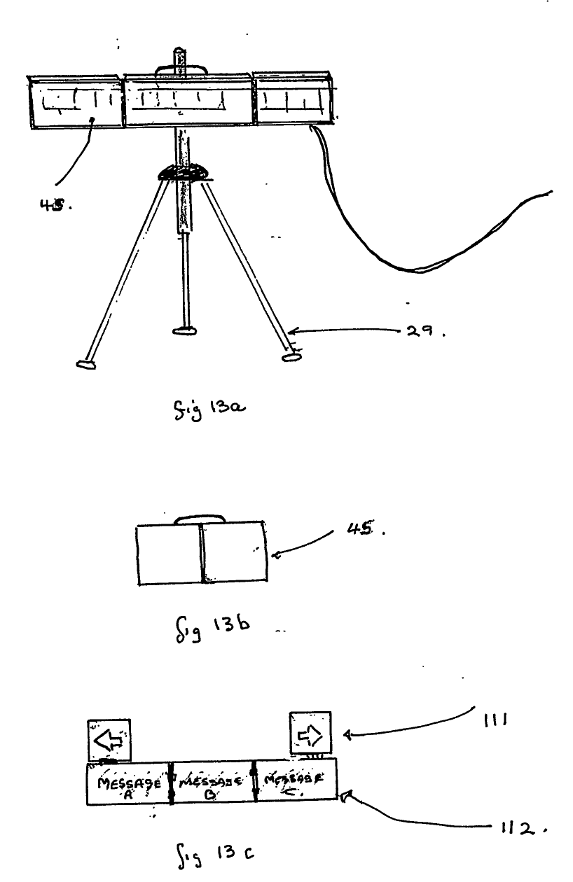

Referring now to drawing 9 and 10. Drawing 9 shows, the apparatus of the invention incorporated within an existing automotive rubbing strip or profiled to outline and identify particular vehicles. Drawing 10 shows the apparatus of the invention integrated within various automotive accessories. FIG. 9a shows the strip formation or application of the apparatus of the invention as applied to a car door 36. FIG. 9b shows an other application of such device to an emergency vehicle 37 where the strip formation of the device can be applied to parts of the vehicle for ready identification. FIG. 10a shows another variation of the strip application of the apparatus of the invention, for fitting behind a contoured window deflector of a cars bonnet. FIG. 10b, shows another formation of the device applied to the side door of a vehicle, or as part of their protective rubbing strip 35. FIG. 10c shows a similar device incorporated as part of the infill or around the number plate 41 and FIG. 10d shows a similar device applied inside to the profile of a curved windscreen 42.

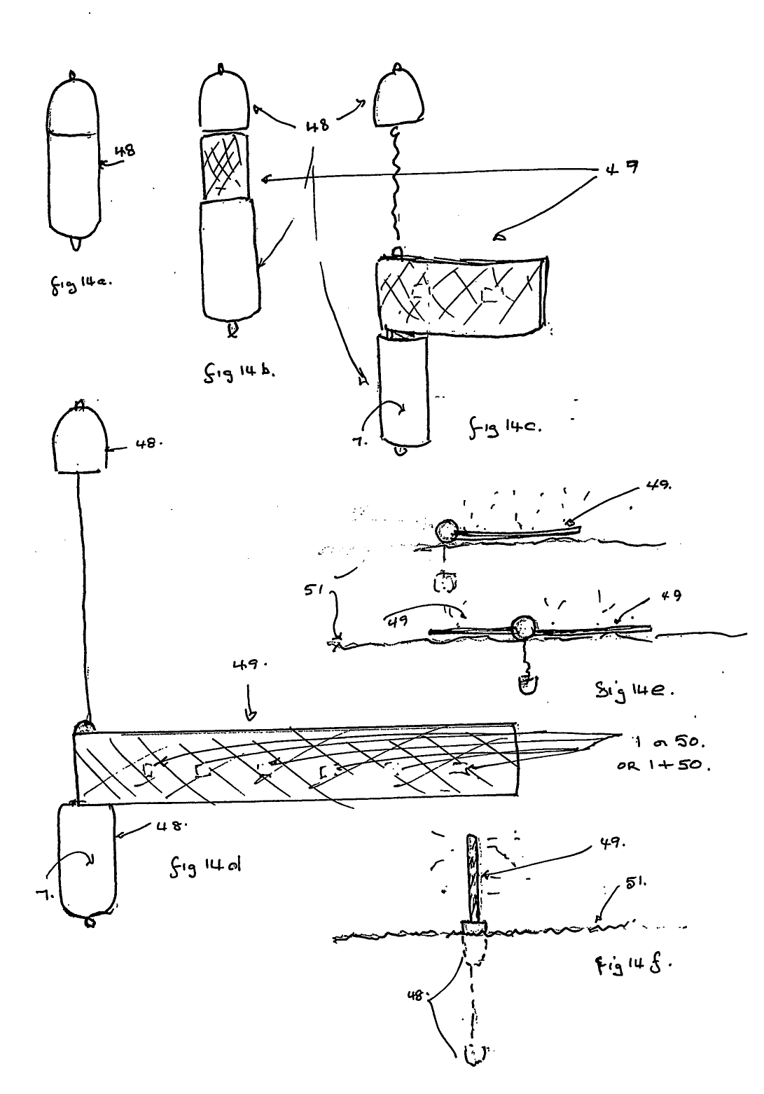

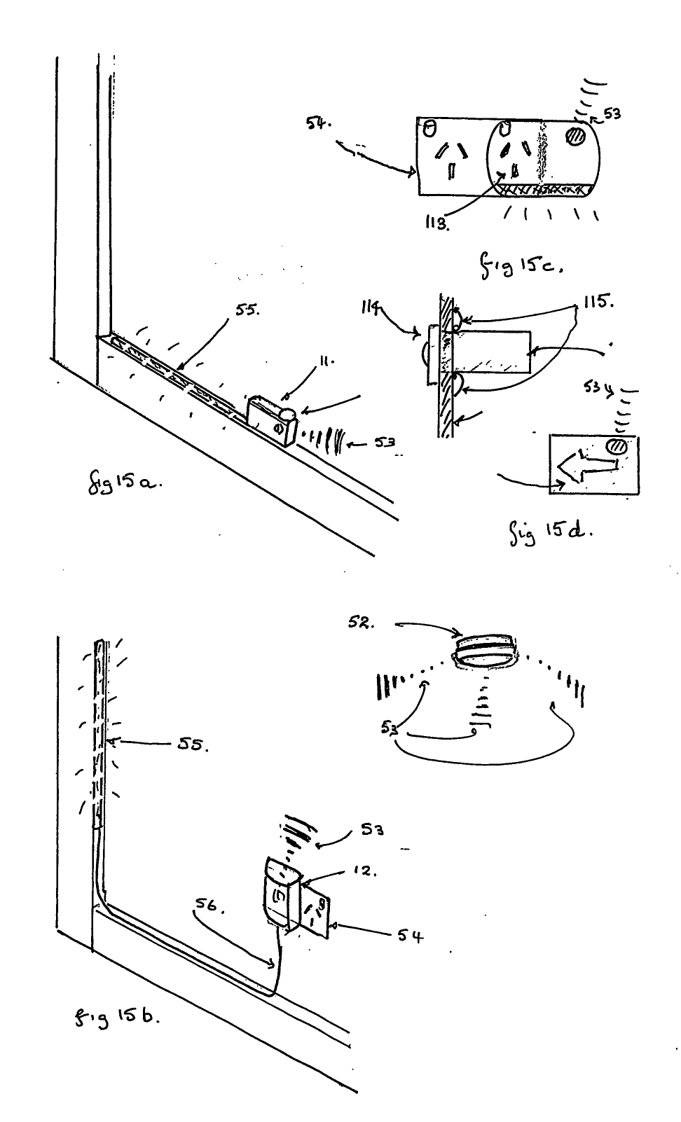

Referring now to drawings 11, 12 and 13. The light emitting diodes are arranged in a plurality of a seven-bit matrix allowing representation of all standard alphabetical and numerical symbols. The flexibility of the invention allows messages to be reproduced as programmed on a range of non-flat surfaces or allows transportation of the message board in simple packaging and assembly at the needed site. In drawing 11, the message board is attached and contoured to follow the shape of the sun visors behind a windscreen. FIG. 11a shows an application of a message board behind the windscreen 43 or sun visor, such that it can be pulled down and readily accessed for reading of the message board. Referring now to FIG. 12a, a message board could be applied permanently to the door of a vehicle or could be configured as a fold out flexible message board 45. Referring now to FIG. 12c, the message board can be manufactured as a flexible compliant device and can be readily applied or configured to a curved position 46. Referring now to FIG. 13, the message board 45 can be applied to a tripod 29 and can incorporate a various folding component 45.

Drawing 14 details an embodiment of the invention for use in marine rescue.

The marine rescue application of the invention, shows a water rescue tube 48, including a very particular application of the apparatus of the invention in the form of a thin special memorised shaped visual indicator 49.

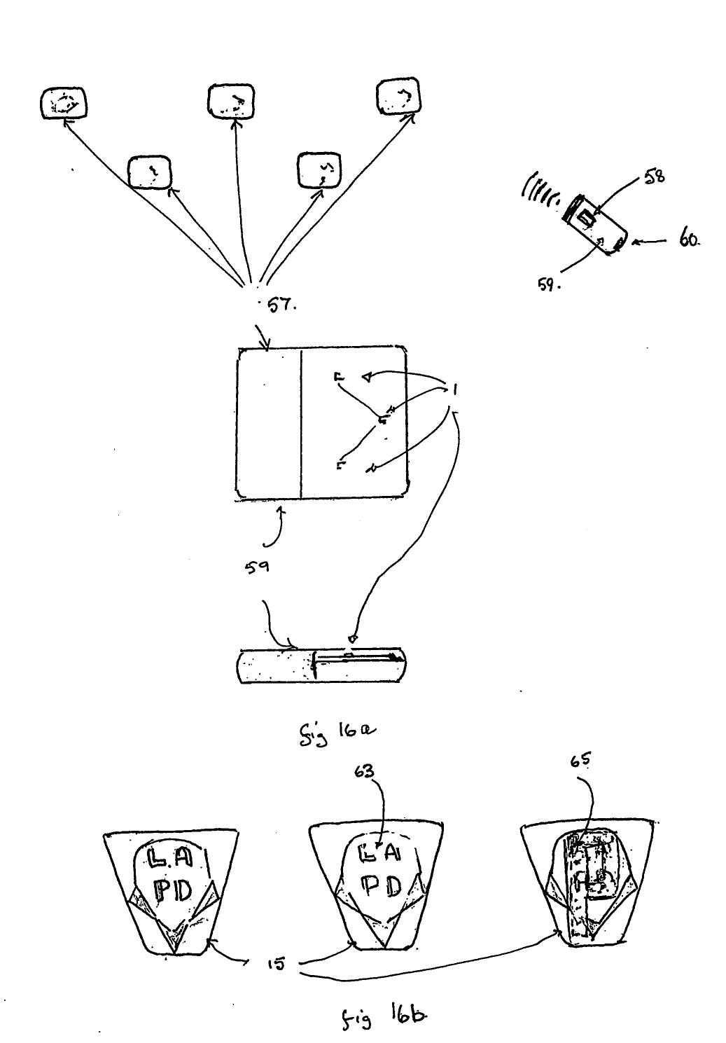

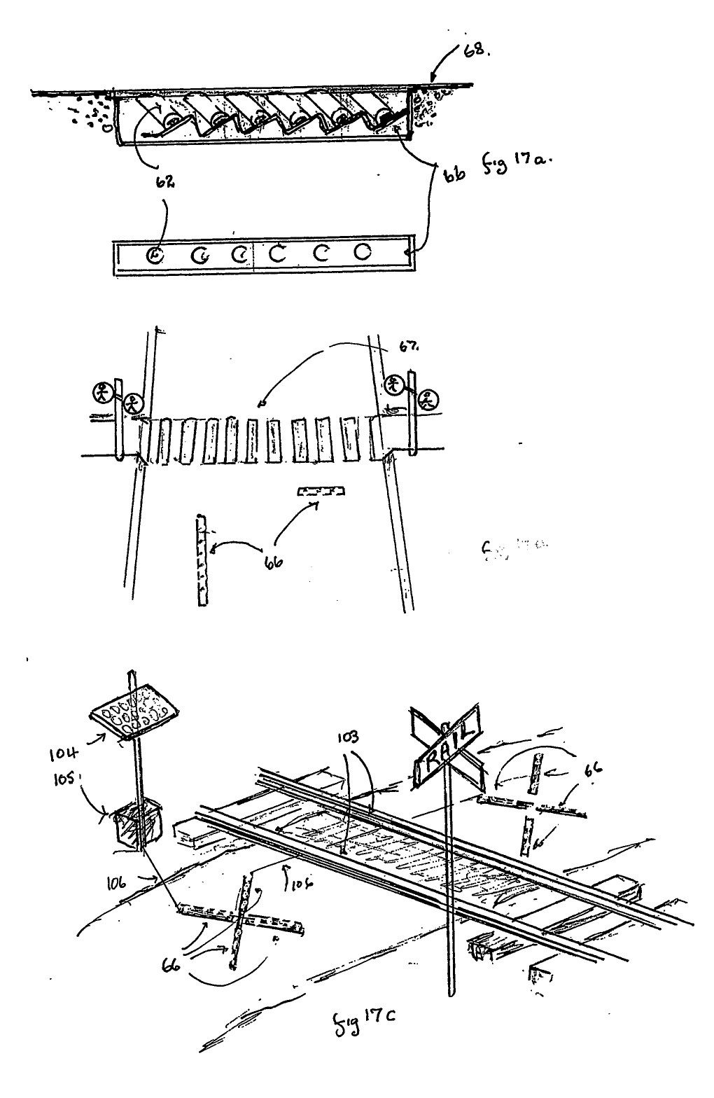

Drawing 15 the apparatus of the invention provides a highly efficient, low maintenance yet simple light pathway triggered by the audio output of a simple domestic smoke alarm and or combined with circuit dropout detection. The smoke detector application of the invention can take the form of a very fine clear covered device incorporating the apparatus of the invention, where a smoke detector 52 will, in the normal situation, provide an audio signal representation 53, which serves to activate the device of the invention, which takes the form of an elongate strip, placed along the skirting board or appropriate parts of a building to indicate an exit route. This application of the invention can rely on integral power source in the form of an enclosed battery, or as detailed in FIG. 15b, can rely on a remote power pack which is connected by wiring 56 to the device of the invention 55.

Drawing 16 provides a particular application for military use as a multiple unit, remote switched stealth walkway. A further embodiment of the badge allows alternative use of infrared LED's within the badge configuration for security identification by infrared detection.

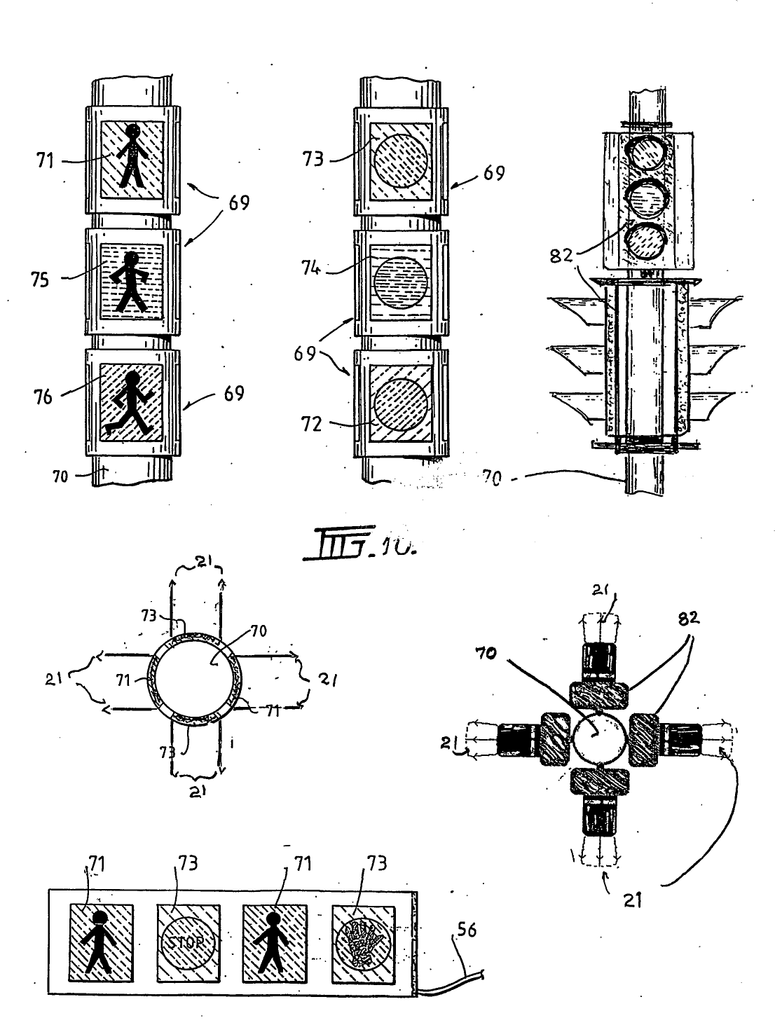

Referring to drawing 17 the ability of the invention being able to fine tune the light emission angles and yet miniaturise a warning signal provides a particular application for roadways adjacent to pedestrian, rail crossings or other designated dangerous road hazards. FIG. 17a shows the apparatus of the invention applied to road surface 68, where the apparatus includes a number of lens mouldings 62. This in-road application of the apparatus of the invention, can also incorporate micro-versions of the apparatus, which require minimal interruption to a road surface and can in fact, be accommodated within a saw width cut into a road surface. The LED's are small enough in size to almost be covered within the texture of a normal road surface and provide a highly efficient device for providing visual signals on a road surface. FIG. 17b shows the application to a pedestrian crossing 67. FIG. 17c, shows application to railway crossing, where the device 66 can be applied within a road surface, leading up to a railway crossing and powered by solar panels 104 and storage batteries 105.

Referring to drawings 18 through to 20 and 22 through to 24 shows various alternative embodiments of the invention where the ability to manipulate the cut off angles from the LED's is critical. Referring firstly to FIG. 18, the apparatus of the invention can be applied to a device for use as a pedestrian lantern, as applied to a power pole 70. The various visual representations for the pedestrian crossing, indicating go, stop and intermediate, can be seen in items 71 to 76. This figure also shows a plan view where the compliant and flexible nature of the apparatus of the invention, particularly lens itself to wrapping around the circular shape of a pole.

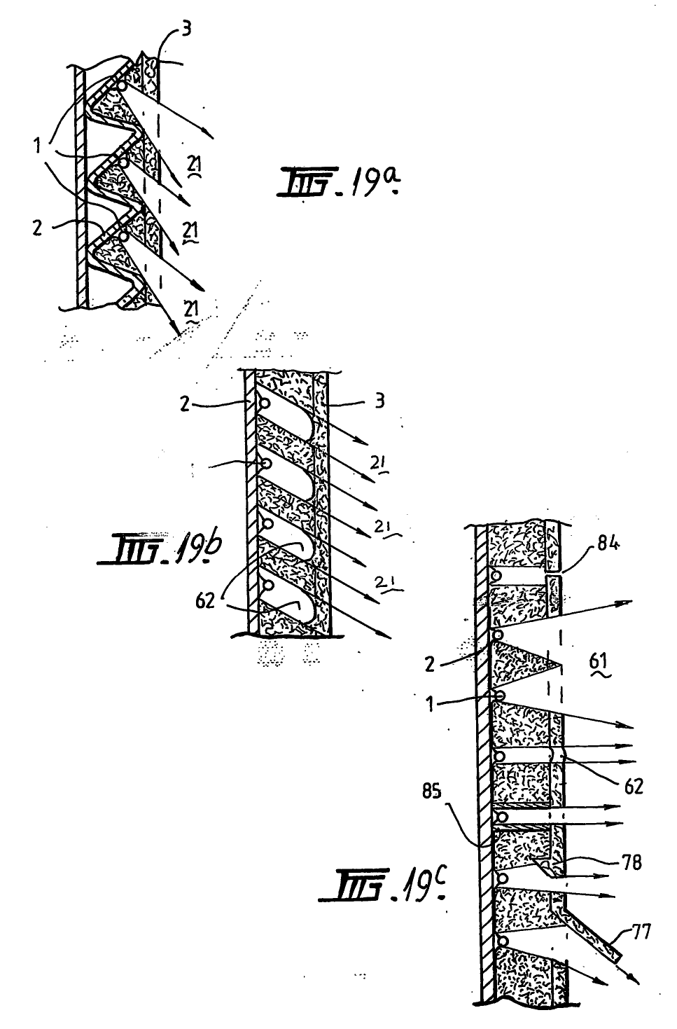

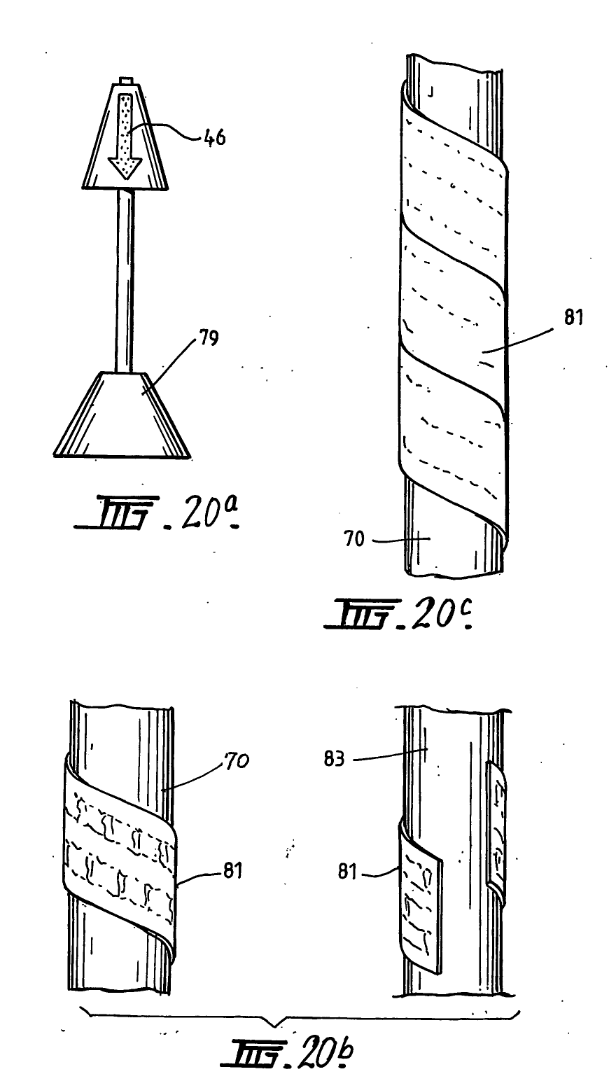

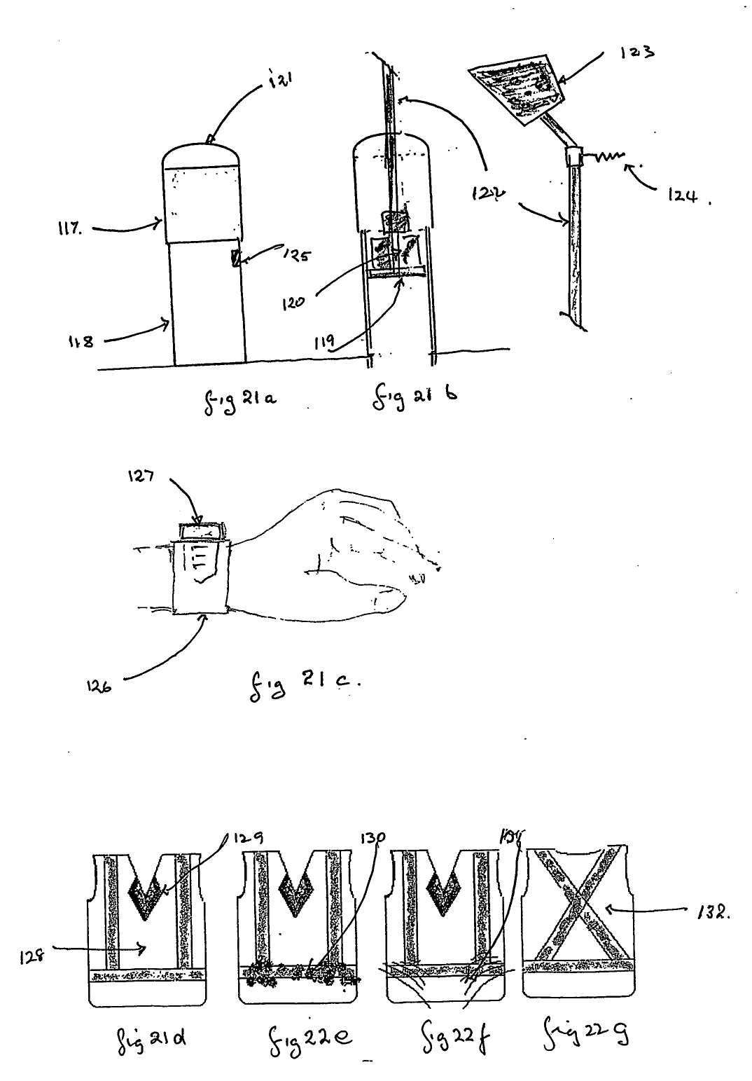

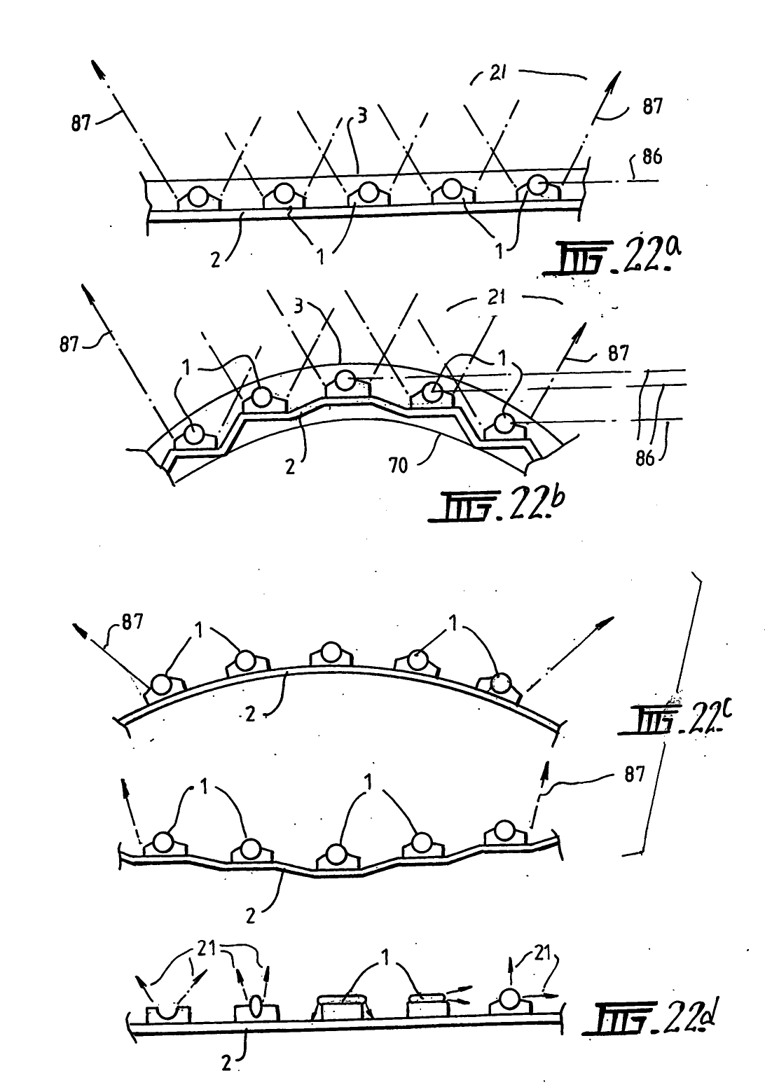

Referring now to FIGS. 19a-c, the directional light output of the apparatus of the invention can be uniquely and precisely controlled while the application of lens mouldings 62, focusing shafts 85, pin holes 84, internal levers 78 and external levers 77. All these various features provide the ability to enhance and direct the printed circuit board, so as to provide a defined angle of illumination for the LED suite of the particular applications in question.

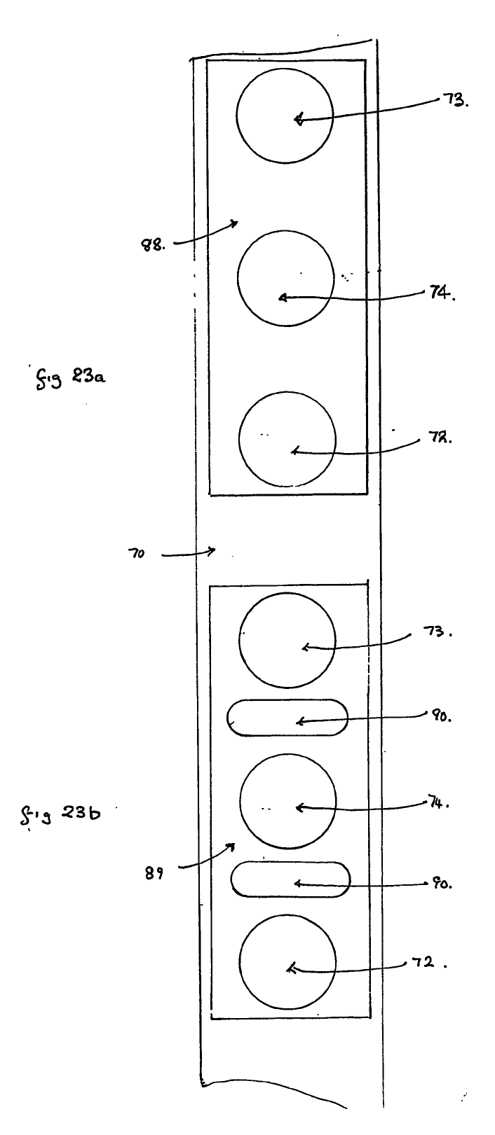

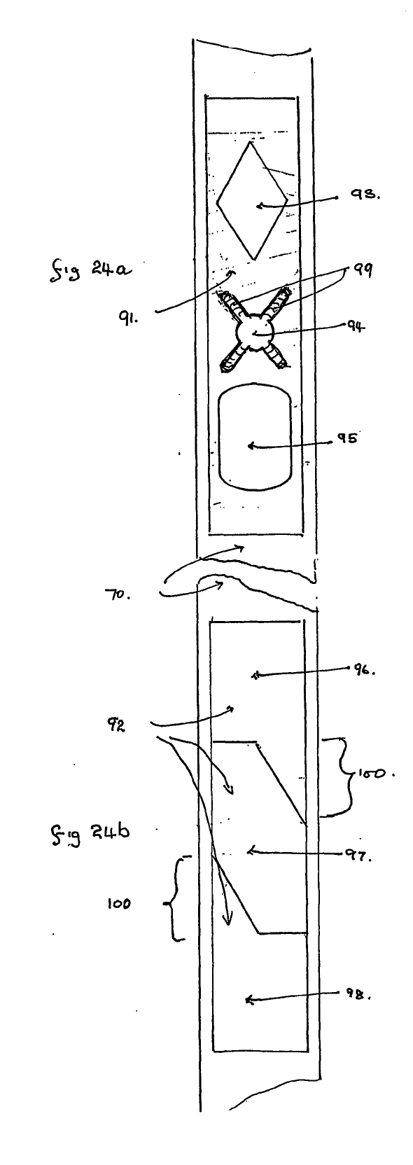

Referring now to FIGS. 22a, b and c. 22a shows a flat printed circuit board with LED's showing the cut off angles generated by light 87. FIG. 22b shows an altered printed circuit board, which is utilised a flexible and compliant nature of the mounting means and has been bent around a curved surface, such that various faces can be configured to remain parallel to each other, by virtue of the highly compliant nature of the printed circuit board. Referring now to FIGS. 23 and 24, the apparatus of the invention finds application in a traffic signal 88, where the various lights 72, 73, 74 and 90, form the illuminated parts of the signal, utilising the apparatus of the invention.

Referring to Drawing 20 shows the apparatus of the invention incorporated within an emergency workers safety vest providing a visual image to an observer. Also incorporated within the vest is a personal safety warning controlled by a remotely triggered signal. The signal may activate a tactile, audio, visual or combination warning within the vest or emergency clothing. The generation of the signal maybe by the automatic detection of a danger or remotely by the site controller.

The invention can be seen to provide a wide range of highly innovative products based on the apparatus of the invention, having a wide range of safety and communication features. The advantages of the invention are by no means limited to the previously described embodiment, but do contain at least following major advantages.
Internally illuminated badges and signs capable of being bent and attached by various means so as to profile or skin a curved or non-flat surface. The PCB is physically modified to provide a distinct angle of mounting for single or groups of LED's to allow a very defined viewing angle when mounted.
   Eg The required cut off viewing angles for traffic signal lights are calculated with the full allowance for the curvature around a pole.
   Where a flat mounting surface is present, the internal PCB maybe manufactured to provide a sloped pad for the mounting of a SMD led at a particular angle to allow total direction light control.
   A flat mounting pad for a Led maybe used where a message is required to be visible up to 360 degrees around a pole. The PCB is pre pressed in manufacture so that when the PCB is fully curved around the pole the LED mounting pads are flat and no solder stress is evident. Similar effect to a fluted lampshade but with flat inner segments rather than sharp angles between the flutes 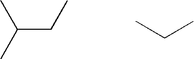
   Specialised shapes such as a cone can have the PCB manufactured to allow special flat LED mountings for specified viewing angles. Note LED's can have their light projected at very defined angles directly in front or totally to one side. Some can have some light back spill and the PCB can be manufactured to reflect most of this light back in the same direction as the major light from the front (or side)
   The light producing LED's within the badge, sign or other designs are encased within a soft bendable or pliable diffusing medium to further allow shape profiling where required. The outer cover being flexible and moulded with possible further light control devices such as lens. The bendable base material maybe of a compressible material to compensate for minor variations in the mounting surfaces.
   The PCB maybe manufactured to be mounted in several planes whilst still allowing the LED solder pads are to be flat thus avoiding solder stress
   The ability to make small very flexible and shallow lights strips allows the use of them on gloves as illuminated traffic control gauntlets.
   A variety of different angled LED's maybe combined with the PCB to achieve the specified angles.
Jacket can be fitted with
   The front LED's apart from their normal use as a visual indication of the wearer are mounted and configured to function as a short focal (arms length) flat torch
   Internal circuitry to produce a visual, audio or tactile warning signal (or any combination) within and/or on a safety jacket to warn the wearer of a possible approaching danger. The danger maybe hidden from the wearer but detectible and signalled by a remote observer with a wireless transmitting control or by detection devices that generate a warning signal automatically. This provides critical extra escape time for a safety worker wearing the vest or jacket.
   The remote external detection devices maybe of many types. They may detect physical movement of the actual detection unit, or the presence of dangerous gas, light changes, electrical circuit triggers, pulse, sound, radar or infrared monitoring devices, changes in air pressure or temperature or fluid levels. All are modified to trigger the safety vest when a dangerous circumstance occurs

Note any safety apparel could be fitted with these features. The hands free torch configuration at the front of the garment, harness or safety clothing and the internal warning devices.

The automatic generation of a signal could also be used for security for the remote detection device from theft or vandalising.

Led Based Illumination Maybe of

LED's
   Normal through hole tailed type
   Surfaced mounted
   Front, rear or side light projection. Angles include less than 10 degrees to over 270 degrees. Performance varies depending where and how the light output is measured
   By the use on internal components including doping with rare earths almost all colours are available.
   They maybe manufactured in singles or supplied in clusters of numerous LED's together. Increase performance
   The maybe a RGB type which combines several separate segments to produce most colours including ‘white’. The colour changes are controlled by a microprocessor within the circuit The same effect maybe obtained by carefully mixing of individually coloured LED's
   Several different colours maybe mounted close together to allow a colour change by microprocessor control switching. One colour turns on whilst another is extinguished

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A visual recognition and identification apparatus comprising a mounting means adapted for placement in a physical environment wherein said mounting means incorporates one or a plurality of light emitting diodes adapted to provide a visual signal characterised in that said LED's are mounted in, on, or connected to a printed circuit board, wherein said printed circuit board is modified to provide a distinct angle of mounting for one or a plurality of LED's to provide a highly defined viewing angle for said apparatus.

2. An apparatus according to claim 1, wherein said mounting angle results in the focusing of said LED's at a defined focal point.

3. An apparatus according to claim 2, wherein said printed circuit board is manufactured from a compliant material, but substantially retains said LED mounting angle during compliant movement.

4. An apparatus according to claim 3, wherein said printed circuit board forms said mounting means so as to provide a flexible and compliant apparatus.

5. An apparatus according to claim 1 wherein said printed circuit board is controlled by a microprocessor.

6. An apparatus according to claim 1 wherein said printed circuit board incorporates a microprocessor microchip for controlling said LED's.

7. An apparatus according to claim 5 wherein said microprocessor is programmable.

8. An apparatus according to claim 1, wherein said mounting means is a sloped pad.

9. An apparatus according to claim 1, wherein said mounting means is an elongate strip.

10. An apparatus according to claim 1, wherein said mounting means is a sealed tube containing said LED's.

11. An apparatus according to claim 1, wherein said mounting means is a shaped moulding.

12. An apparatus according to claim 1, wherein said mounting means including a power supply for said LED's.

13. An apparatus according to claim 12 wherein said power supply is a rechargeable battery.

14. An apparatus according to claim 1, wherein said LED's emit ultraviolet wavelength and/or infrared light in addition to said visual signal.

15. An apparatus according to claim 1, wherein said mounting means includes a protective cover.

16. An apparatus according to claim 15, wherein said protective cover includes any one or a combination of integrated lenses, covers or other means to control the directional output of said apparatus.

17. An apparatus according to claim 1, wherein said LED's are switched.

18. An apparatus according to claim 17, wherein said switch is an automatic detector activated by a select signal.

19. An apparatus according to claim 18, wherein said select signal is smoke.

20. An apparatus according to claim 18, wherein said select signal is sound.

21. An apparatus according to claim 18, wherein said select signal is temperature.

22. An apparatus according to claim 1, wherein said LED's are programmed to emit a pulsed light signal.

23. An apparatus according to claim 12, wherein said LED, printed circuit board and power supply are formed as a sealed illuminated decal.

24. A badge adapted for placement on a wearer's clothing including an apparatus according to claim 1.

25. A badge according to claim 24, wherein the mounting means includes a clip for attachment to a wearer's clothing.

26. A badge according to claim 24, wherein the mounting means includes a slip-on fitting for attachment to a wearer's clothing.

27. A clothing accessory including an apparatus according to claim 1, wherein the mounting means is adapted for sewing into an item of clothing and incorporation therewith.

28. An accessory according to claim 27 wherein said power supply is a rechargeable battery, adapted for storage in a pocket of said clothing.

29. A clothing patch including an apparatus according to claim 1, wherein said patch is adapted for sewing onto the item of clothing.

30. A clothing patch according to claim 29 adapted for fitting to a shirt sleeve, a cap or any other item of clothing.

31. An animal collar including an apparatus according to claim 1.

32. An emergency warning device including an apparatus according to claim 1.

33. A device according to claim 32 including any one or a combination of fixing means selected from the group consisting of clips, self adhesive tape, magnetic stripping, handles and suckers.

34. A fire alarm system including an apparatus according to claim 1, wherein said apparatus is adapted for positioning on skirting boards, door architraves and windows and wherein said alarm is adapted for sound activation by a smoke alarm or other wireless means.

35. A fire alarm system according to claim 34 wherein said activation is by an RF generator via a dedicated signal to said apparatus.

36. A message board including an apparatus according to claim 1 wherein said apparatus is adapted to visually display said message.

37. A message board according to claim 36, wherein said apparatus is programmable to display a message of choice and is able to amend said message as required.

38. A road message or warning device including an apparatus according to claim 1 wherein said apparatus is installed into a road surface.

39. A device according to claim 38, incorporated as part of a pedestrian crossing or railway warning crossing.

40. A road traffic signal including an apparatus according to claim 1, wherein the visual signal is provided by said apparatus.

41. A traffic signal according to claim 40 wherein said apparatus is directionally sensitive so as to provide lane definition.

42. A traffic signal according to claim 40 or 41 wherein said apparatus is activated by an indicative loop in said road.

43. A point of sale message board including an apparatus as claimed in claim 1.

44. An apparatus according to claim 6, wherein said microprocessor is programmable.
